(19) United States
(12) Patent Application Publication
(10) Pub. No.: US 2026/0032653 A1
(43) Pub. Date: Jan. 29, 2026

(54) RESOURCE MUTING PATTERNS

(71) Applicant: QUALCOMM Incorporated, San Diego, CA (US)

(72) Inventors: Jae Ho RYU, San Diego, CA (US); Qian ZHANG, Basking Ridge, NJ (US); Muhammad Sayed Khairy ABDELGHAFFAR, San Jose, CA (US); Prashant SHARMA, San Marcos, CA (US)

(21) Appl. No.: 19/255,146

(22) Filed: Jun. 30, 2025

Related U.S. Application Data
(60) Provisional application No. 63/676,564, filed on Jul. 29, 2024.

(51) Int. Cl. H04W 72/0446; H04W 72/232

(52) U.S. Cl. CPC H04W 72/0446; H04W 72/232

(57) ABSTRACT

Various aspects of the present disclosure generally relate to wireless communication. In some aspects, a user equipment (UE) may receive configuration information indicating a resource muting pattern, wherein the resource muting pattern is associated with a first one or more symbols, within a time interval associated with a set of resources, during which the resource muting pattern is to be applied. The UE may transmit one or more signals in one or more available resources, from the set of resources, in accordance with the resource muting pattern. Numerous other aspects are described.

### CROSS-REFERENCE TO RELATED APPLICATION

This patent application claims priority to U.S. Provisional Patent Application No. 63/676,564, filed on Jul. 29, 2024, entitled “RESOURCE MUTING PATTERNS,” and assigned to the assignee hereof. The disclosure of the prior Application is considered part of and is incorporated by reference into this patent application.

### FIELD OF THE DISCLOSURE

Aspects of the present disclosure generally relate to wireless communication and specifically relate to techniques, apparatuses, and methods for resource muting patterns.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, an apparatus for wireless communication includes one or more memories; and one or more processors, coupled to the one or more memories, the one or more processors individually or collectively configured to: receive configuration information indicating a resource muting pattern, wherein the resource muting pattern is associated with a first one or more symbols, within a time interval associated with a set of resources, during which the resource muting pattern is to be applied; and transmit one or more signals in one or more available resources, from the set of resources, in accordance with the resource muting pattern.

In some aspects, an apparatus for wireless communication includes one or more memories; and one or more processors, coupled to the one or more memories, the one or more processors individually or collectively configured to: transmit configuration information indicating a resource muting pattern, wherein the resource muting pattern is associated with a first one or more symbols, within a time interval associated with a set of resources, during which the resource muting pattern is to be applied; and receive one or more signals in one or more available resources, from the set of resources, in accordance with the resource muting pattern.

In some aspects, a method of wireless communication performed by a user equipment (UE) includes receiving configuration information indicating a resource muting pattern, wherein the resource muting pattern is associated with a first one or more symbols, within a time interval associated with a set of resources, during which the resource muting pattern is to be applied; and transmitting one or more signals in one or more available resources, from the set of resources, in accordance with the resource muting pattern.

In some aspects, a method of wireless communication performed by a network node includes transmitting configuration information indicating a resource muting pattern, wherein the resource muting pattern is associated with a first one or more symbols, within a time interval associated with a set of resources, during which the resource muting pattern is to be applied; and receiving one or more signals in one or more available resources, from the set of resources, in accordance with the resource muting pattern.

In some aspects, a non-transitory computer-readable medium storing a set of instructions for wireless communication includes one or more instructions that, when executed by one or more processors of a UE, cause the UE to: receive configuration information indicating a resource muting pattern, wherein the resource muting pattern is associated with a first one or more symbols, within a time interval associated with a set of resources, during which the resource muting pattern is to be applied; and transmit one or more signals in one or more available resources, from the set of resources, in accordance with the resource muting pattern.

In some aspects, a non-transitory computer-readable medium storing a set of instructions for wireless communication includes one or more instructions that, when executed by one or more processors of a network node, cause the network node to: transmit configuration information indicating a resource muting pattern, wherein the resource muting pattern is associated with a first one or more symbols, within a time interval associated with a set of resources, during which the resource muting pattern is to be applied; and receive one or more signals in one or more available resources, from the set of resources, in accordance with the resource muting pattern.

In some aspects, an apparatus for wireless communication includes means for receiving configuration information indicating a resource muting pattern, wherein the resource muting pattern is associated with a first one or more symbols, within a time interval associated with a set of resources, during which the resource muting pattern is to be applied; and means for transmitting one or more signals in one or more available resources, from the set of resources, in accordance with the resource muting pattern.

In some aspects, an apparatus for wireless communication includes means for transmitting configuration information indicating a resource muting pattern, wherein the resource muting pattern is associated with a first one or more symbols, within a time interval associated with a set of resources, during which the resource muting pattern is to be applied; and means for receiving one or more signals in one or more available resources, from the set of resources, in accordance with the resource muting pattern.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example network node in communication with an example user equipment (UE) in a wireless network.

FIG. 3 is a diagram illustrating an example disaggregated base station architecture.

FIG. 4 is a diagram illustrating examples of full-duplex communication in a wireless network.

FIG. 5 is a diagram illustrating examples of full-duplex communications.

FIG. 6 is a diagram illustrating an example of cross-link interference.

FIG. 7 is a diagram of an example associated with resource muting patterns.

FIG. 8 is a diagram of an example associated with resource muting patterns.

FIG. 9 is a diagram of an example associated with resource muting patterns.

FIG. 10 is a diagram illustrating an example process performed, for example, at a UE or an apparatus of a UE.

FIG. 11 is a diagram illustrating an example process performed, for example, at a network node or an apparatus of a network node.

FIG. 12 is a diagram of an example apparatus for wireless communication.

FIG. 13 is a diagram of an example apparatus for wireless communication.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

“Full-duplex communication” in a wireless network refers to simultaneous bi-directional communication between devices in the wireless network. In sub-band full duplex (SBFD), a network node may receive an uplink communication from a user equipment (UE) and transmit a downlink communication to a UE at the same time, but on different frequency resources. In some scenarios, SBFD operation may lead to inter-network-node cross-link interference (CLI). Inter-network-node CLI may occur when reception of a communication (for example, from a UE) at a network node overlaps in time with transmission of a communication from a neighboring network node. For example, the communication transmitted from the neighboring network node may interfere with the communication received from the UE.

In some examples, uplink resource muting may be used to support an inter-network-node CLI measurement and thereby suppress inter-network-node CLI. Uplink resource muting may involve muting of one or more uplink resources (for example, one or more UEs may refrain from transmitting uplink communications on the uplink resource(s)). “Muting” a resource refers to a wireless communication device refraining from using the resource (e.g., a time-frequency resource, such as a resource block (RB) or a resource element (RE)) for communication of data or control information (e.g., for transmission or reception of data or control information). As an example, a first network node (e.g., a victim network node) may receive a CLI reference signal from a second network node (e.g., an aggressor network node). The first network node may measure the CLI reference signal in order to determine a CLI level caused by the second network node. In order to accurately measure the CLI reference signal to obtain the CLI level, the first network node may mute an uplink transmission from a UE associated with the first network node, such that an entire uplink channel at a given time is dedicated for measuring the CLI reference signal. The uplink transmission may be muted when a timing of the uplink transmission corresponds to a timing of the CLI reference signal. The UE and the first network node may be associated with a same cell. When the uplink transmission is not muted, an accuracy of a CLI reference signal measurement may be degraded, which may result in a less accurate measurement of the CLI level. A muting of the uplink transmission may be referred to as an uplink resource muting, such that certain uplink resources are not used for the uplink transmission in order to improve a measurement accuracy of the CLI reference signal. The uplink resource muting may be a non-transparent uplink resource muting, in which case the UE obtains an indication of the uplink resource muting.

In some examples, an uplink resource muting pattern may be applicable for up to M time intervals within N time intervals (e.g., where N is greater than or equal to M). As an example, the M time intervals may be M orthogonal frequency division multiplexing (OFDM) symbols and the N time intervals may include a slot or a time domain resource allocation for a given channel (e.g., a physical uplink shared channel (PUSCH) time domain resource allocation). For example, a value of M may be greater than one, such as two, three, or another quantity. An uplink resource muting pattern may be applicable for all allocated RBs and up to M time intervals in the time domain (e.g., for all allocated RBs and up to 2 OFDM symbols in the time domain).

However, it may be unclear or undefined which M time intervals within N time intervals are to be associated with the uplink resource muting pattern. For example, in non-transparent uplink resource muting, a network node may transmit, and the UE may receive, an indication that the uplink resource muting pattern is to be applied. The uplink resource muting pattern may indicate which resources are to be muted in the frequency domain (e.g., a comb-2 pattern may indicate that every second RE or RB is to be muted in the frequency domain). However, the uplink resource muting pattern may not indicate which time domain resources (e.g., which M time intervals) during which the uplink resource muting pattern is to be applied. As a result, the UE may apply the uplink resource muting pattern during a time interval (e.g., an OFDM symbol or another time interval) that is not expected or intended by the network node. This may degrade CLI measurement performance by the network node because the UE may transmit uplink signal(s) during time-frequency resources in which the network node is measuring a CLI reference signal. Additionally, this may increase latency and/or decrease throughput for the UE because the UE may incorrectly refrain from transmitting uplink signal(s) during the muted resources that would otherwise be available for use by the UE.

Further, one or more reference signals may be configured to occur during some time intervals. For example, one or more demodulation reference signals (DMRSs), phase tracking reference signals (PTRSs), and/or other reference signals may be configured to be transmitted by the UE during some time intervals (e.g., during some OFDM symbols). If the UE applies the resource muting pattern to time-frequency resources during which a reference signal is configured to be transmitted, the UE may refrain from transmitting the reference signal. This may degrade communication performance between the UE and the network node if the network node expects that the reference signal is to be transmitted. For example, the network node may attempt to receive and/or measure the reference signal. However, if the UE does not transmit the reference signal in accordance with the resource muting pattern, then the network node may needlessly consume processing resources associated with attempting to receive, measure, and/or otherwise process the reference signal. Additionally, or alternatively, the network node may identify that a measurement of the reference signal is low or zero (e.g., because the UE does not actually transmit the reference signal when expected by the network node), resulting in the network node needlessly performing one or more actions based on, or in response to, the identified low measurement of the reference signal.

Various aspects relate generally to resource muting patterns. Some aspects more specifically relate to indicating time domain locations during which a resource muting pattern is to be applied. In some aspects, a network node may transmit, and a UE may receive, configuration information indicating a resource muting pattern. The resource muting pattern may be associated with a first one or more time intervals (e.g., a first one or more symbols), within a second time interval associated with a set of resources, during which the resource muting pattern is to be applied. In some aspects, one or more positions (e.g., in the time domain) of the first one or more time intervals (e.g., of the first one or more symbols) is based at least in part on the second time interval (e.g., may be defined according to a size or span of the second time interval). The UE may transmit one or more signals in one or more available resources, from the set of resources, in accordance with the resource muting pattern.

Particular aspects of the subject matter described in this disclosure can be implemented to realize one or more of the following potential advantages. In some examples, by the UE and/or the network node defining the time domain location(s) of the first one or more time intervals (e.g., of the first one or more symbols) within the second time interval, the described techniques can be used to improve the likelihood that the UE and the network node are synchronized as to the time interval(s) during which the UE applies to the resource muting pattern. As a result, the UE may apply the resource muting pattern during time interval(s) (e.g., an OFDM symbol or another time interval) that are expected or intended by the network node. This may improve CLI measurement performance by the network node because the UE may refrain from transmitting uplink signal(s) during time-frequency resources in which the network node is measuring a CLI reference signal.

In some aspects, the configuration information may indicate the one or more positions of the first one or more time intervals during which the resource muting pattern is to be applied. For example, the configuration information may indicate which OFDM symbol(s) (e.g., the first one or more time intervals) during the second time interval (e.g., a slot, a mini-slot, or a time domain resource allocation for a channel) to which the UE is to apply the resource muting pattern. In other aspects, the one or more positions of the first one or more time intervals may be indicated via one or more rules and information associated with the second time interval. For example, a rule may define the one or more positions of the first one or more time intervals relative to the second time interval.

In some aspects, the configuration information may indicate whether the UE is to apply the resource muting pattern during time intervals that are configured for use for a reference signal (e.g., a DMRS, a PTRS, or another reference signal). In some aspects, the UE applying the resource muting pattern during time intervals that are configured for use for a reference signal may be based at least in part on, or otherwise associated with, a size of the second time interval. For example, if the size of the second time interval does not satisfy a threshold, then the UE may apply the resource muting pattern during time intervals that are configured for use for the reference signal. If the size of the second time interval does satisfy the threshold, then the UE may refrain from applying the resource muting pattern during time intervals that are configured for use for the reference signal. In some aspects, if the resource muting pattern is not applicable to time intervals that are configured for use for a reference signal, then the UE may disregard the time intervals that are configured for use for a reference signal when determining the one or more positions of the first one or more time intervals (e.g., time intervals (such as OFDM symbols) configured with a reference signal may not be counted in muting symbol determinations by the UE).

In some aspects, by the UE and the network node using the second time interval to define the one or more positions of the first one or more time intervals, the configuration information and/or the one or more rules may use a simple and reliable mechanism for the UE and the network node to identify during which time intervals (e.g., which OFDM symbols) the resource muting pattern is to be applied. Additionally, by the UE obtaining an indication of whether the UE is to apply the resource muting pattern during time intervals that are configured for use for a reference signal, the likelihood of the application of the resource muting pattern negatively impacting the performance of the reference signal may be reduced.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

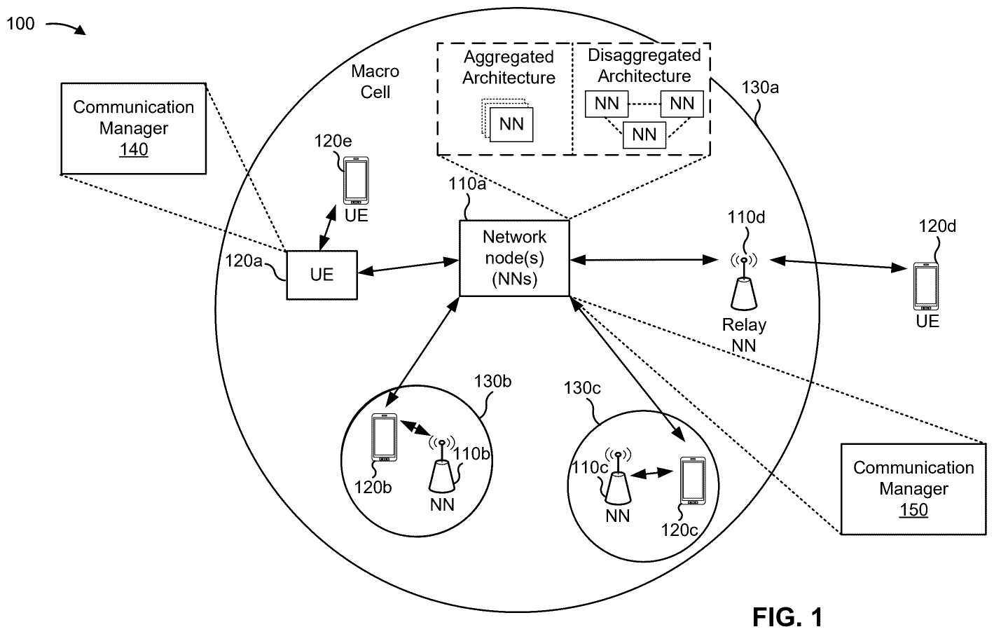

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FRI, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more PUSCHs. The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced cMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120c in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive configuration information indicating a resource muting pattern, wherein the resource muting pattern is associated with a first one or more symbols, within a time interval associated with a set of resources, during which the resource muting pattern is to be applied, and wherein one or more positions of the first one or more symbols is based at least in part on the time interval; and transmit one or more signals in one or more available resources, from the set of resources, in accordance with the resource muting pattern. Additionally, or alternatively, the communication manager 140 may perform one or more other operations described herein.

In some aspects, the network node 110 may include a communication manager 150. As described in more detail elsewhere herein, the communication manager 150 may transmit configuration information indicating a resource muting pattern, wherein the resource muting pattern is associated with a first one or more symbols, within a time interval associated with a set of resources, during which the resource muting pattern is to be applied, and wherein one or more positions of the first one or more symbols is based at least in part on the time interval; and receive one or more signals in one or more available resources, from the set of resources, in accordance with the resource muting pattern. Additionally, or alternatively, the communication manager 150 may perform one or more other operations described herein.

As indicated above, FIG. 1 is provided as an example. Other examples may differ from what is described with regard to FIG. 1.

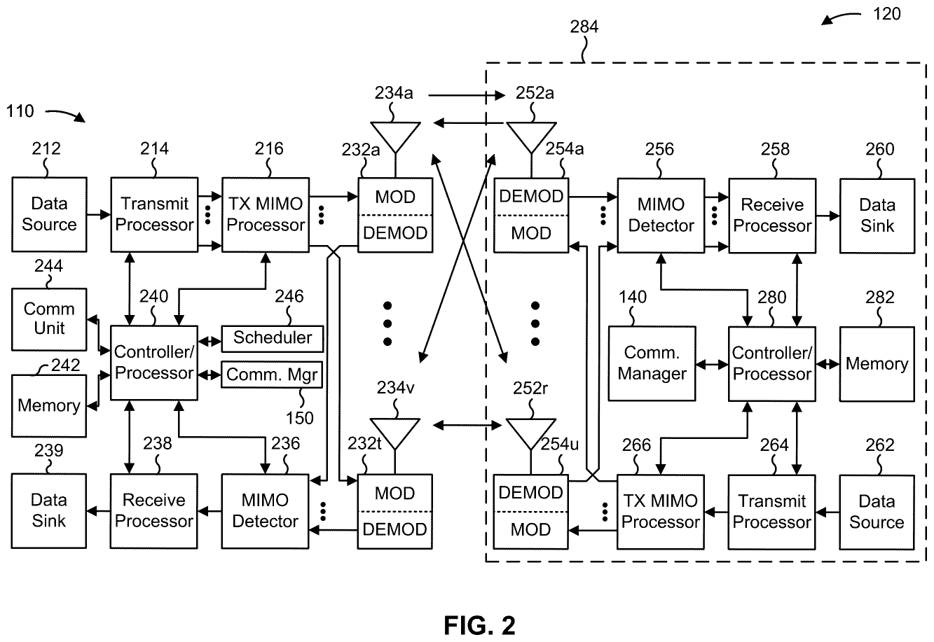

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and control signals (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for OFDM) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

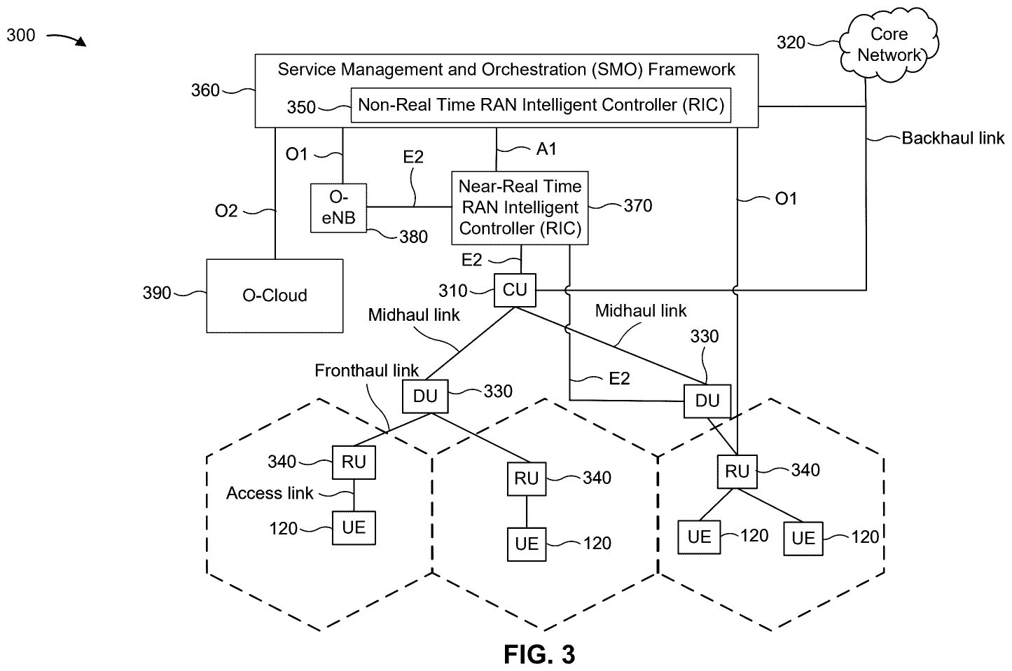

FIG. 3 is a diagram illustrating an example disaggregated base station architecture 300. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-cNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

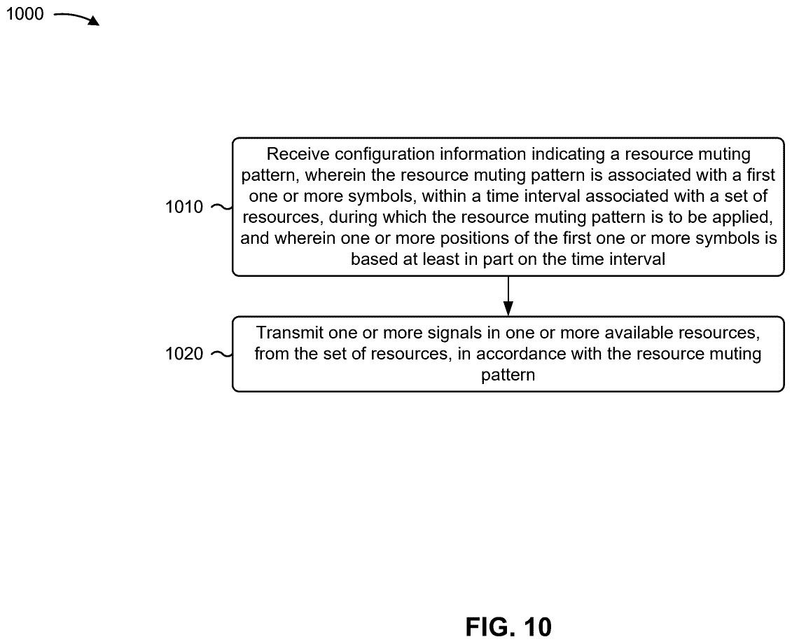

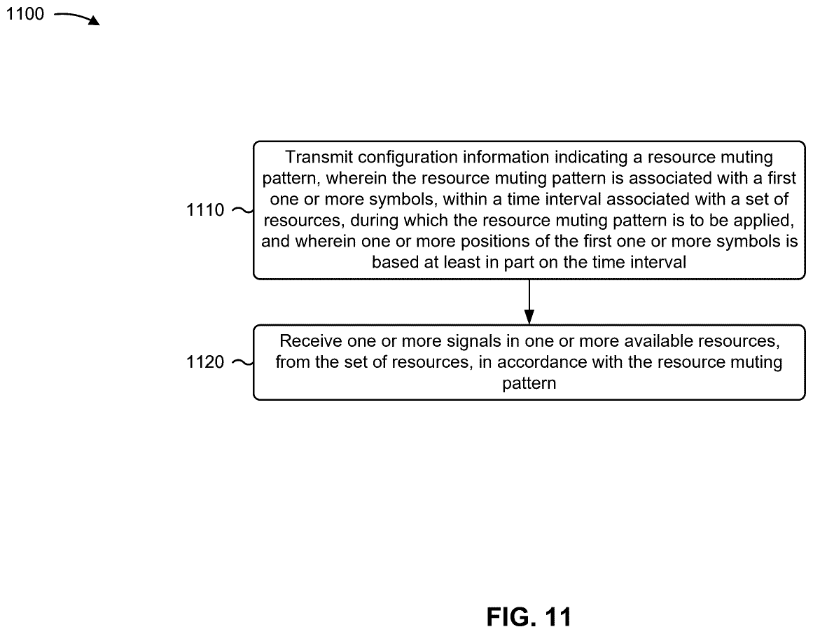

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with resource muting patterns, as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 1000 of FIG. 10, process 1100 of FIG. 11, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

In some aspects, the UE 120 includes means for receiving configuration information indicating a resource muting pattern, wherein the resource muting pattern is associated with a first one or more symbols, within a time interval associated with a set of resources, during which the resource muting pattern is to be applied, and wherein one or more positions of the first one or more symbols is based at least in part on the time interval; and/or means for transmitting one or more signals in one or more available resources, from the set of resources, in accordance with the resource muting pattern. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting configuration information indicating a resource muting pattern, wherein the resource muting pattern is associated with a first one or more symbols, within a time interval associated with a set of resources, during which the resource muting pattern is to be applied, and wherein one or more positions of the first one or more symbols is based at least in part on the time interval; and/or means for receiving one or more signals in one or more available resources, from the set of resources, in accordance with the resource muting pattern. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

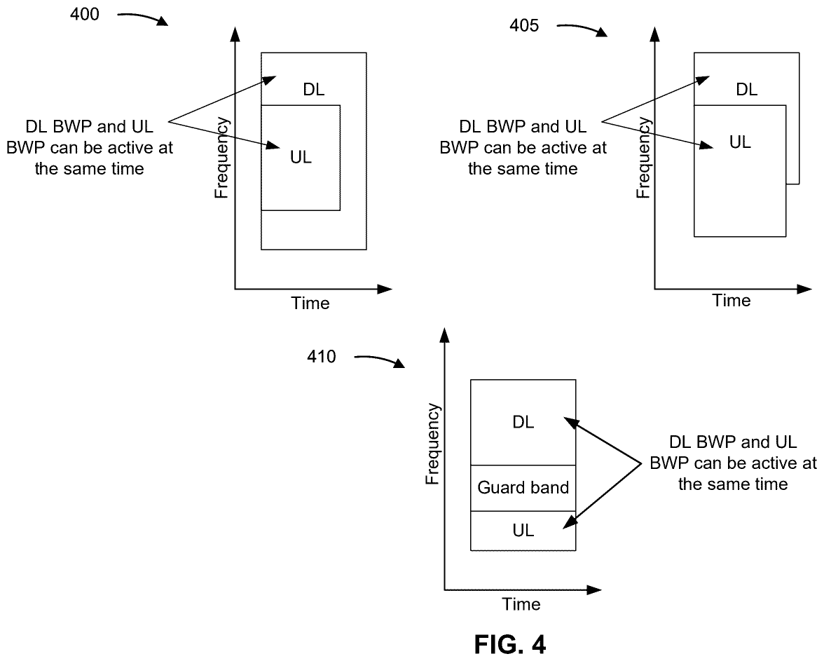

FIG. 4 is a diagram illustrating examples 400, 405, and 410 of full-duplex communication in a wireless network. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 4, examples 400 and 405 show examples of in-band full-duplex (IBFD) communication. IBFD may be a type of full-duplex communication. In IBFD, a UE may transmit an uplink communication to a base station and receive a downlink communication from the base station on the same time and frequency resources. As shown in example 400, in a first example of IBFD, the time and frequency resources for uplink communication may fully overlap with the time and frequency resources for downlink communication. As shown in example 405, in a second example of IBFD, the time and frequency resources for uplink communication may partially overlap with the time and frequency resources for downlink communication.

As further shown in FIG. 4, example 410 shows an example of SBFD communication, which may also be referred to as “sub-band frequency division duplex (SBFDD)” or “flexible duplex.” SBFD may be a type of full-duplex communication. In SBFD, a UE may transmit an uplink communication to a base station and receive a downlink communication from the base station at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

As indicated above, FIG. 4 is provided as an example. Other examples may differ from what is described with respect to FIG. 4.

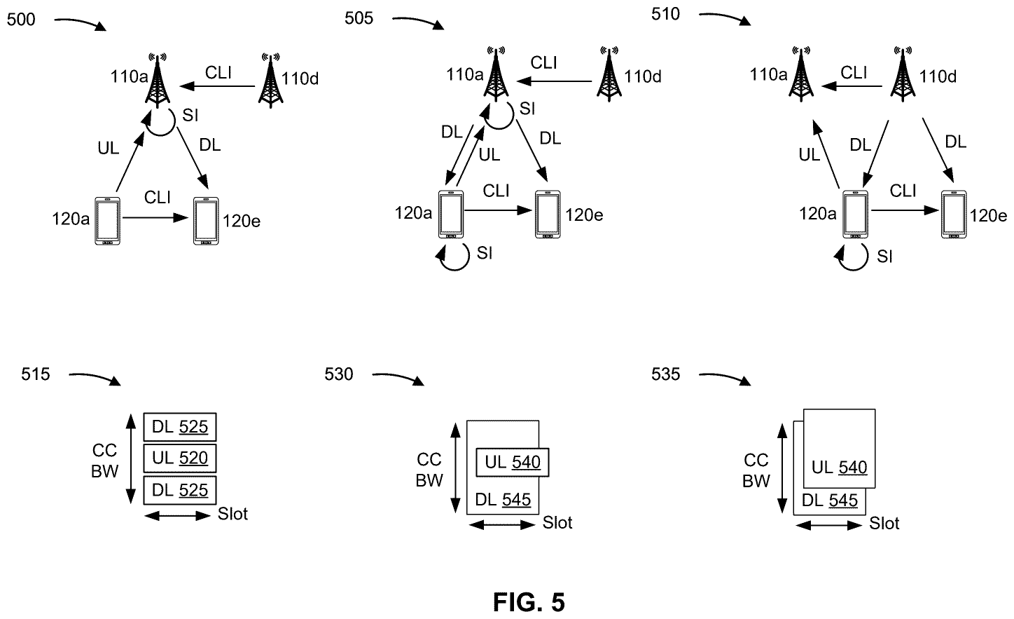

FIG. 5 is a diagram illustrating examples 500, 505, and 510 of full-duplex communications. In examples 500, 505, and 510, network node 110a and/or network node 110d may communicate with UEs 120a and/or UEs 120c.

In example 500, the network nodes 110a and 110d may be full-duplex network nodes, and UEs 120a and 120e may be half-duplex UEs. As shown, network node 110a may receive an uplink transmission (“UL”) from the UE 120a and transmit a downlink transmission (“DL”) to the UE 120e. The network node 110a may simultaneously receive the uplink transmission and transmit the downlink transmission on the same slot. In some examples, the network node 110a may experience self-interference (“SI”) as a result of the downlink transmission leaking into a port that receives the uplink transmission. Additionally, or alternatively, the UE 120e may be subjected to CLI from the UE 120a (for example, inter-UE CLI). Additionally or alternatively, the network node 110a may be subjected to CLI from the network node 110d (for example, inter-network-node CLI, sometimes referred to as inter-gNB CLI, network node-to-network node interference, or gNB-to-gNB interference).

As used herein, CLI refers to interference experienced for an uplink reception caused by a downlink transmission from another wireless communication device during a transmission time interval (TTI). For example, a network node 110 may configure a TDD configuration (e.g., a TDD pattern) with more uplink TTIs (e.g., frames, subframes, slots, mini-slots, and/or symbols) for a UE 120 when the UE 120 has uplink data to transmit, and may configure a TDD configuration with more downlink TTIs for the UE 120 when the UE 120 has downlink data to receive. The TDD configuration may be dynamically configured to modify the allocation of uplink TTIs and downlink TTIs used for communication between the network node 110 110 and the UE 120. When neighboring network nodes 110 use different TDD configurations to communicate with UEs 120, this may result in a downlink communication between a first network node 110 and a first UE 120 in a same TTI as an uplink communication between a second network node 110 and a second UE 120. These communications in different transmission directions (e.g., downlink vs. uplink) in the same TTI may interfere with one another, which may be referred to as cross-link interference.

In example 505, the network nodes 110a and 110d may be full-duplex network nodes, and UEs 120a and 120e may be full-duplex UEs. As shown, network node 110a may receive an uplink transmission from the UE 120a and transmit downlink transmissions to respective UEs 120a and 120c. The network node 110a may simultaneously receive the uplink transmission and transmit the downlink transmissions on the same slot. In some examples, the network node 110a may experience self-interference as a result of the downlink transmission(s) leaking into a port that receives the uplink transmission. Additionally, or alternatively, the UE 120e may be subjected to CLI (for example, inter-UE CLI) from the UE 120a. Additionally or alternatively, the network node 110a may be subjected to CLI (for example, inter-network-node CLI) from the network node 110d. Additionally, or alternatively, the UE 120a may experience self-interference as a result of the uplink transmission leaking into a port that receives the downlink transmission to the UE 120a.

In example 510, the network nodes 110a and 110d may be full-duplex network nodes, and UEs 120a and 120e may be SBFD UEs. Example 510 may involve a multiple transmission reception point (M-TRP) scenario in which both network nodes 110a and 110d serve UEs 120a and 120c simultaneously. As shown, the network node 110a may receive an uplink transmission from the UE 120a, and the network node 110c may transmit downlink transmissions to respective UEs 120a and 120e. The network node 110a may receive the uplink transmission on the same slot that the network node 110d transmits the downlink transmissions (for example, the uplink and downlink transmissions may be simultaneous). Unlike in example 505, the network node 110a may avoid self-interference because the network node 110d, rather than network node 110a, transmits the downlink transmissions to the UEs 120a and 120c. Additionally, or alternatively, the UE 120e may be subjected to CLI from the UE 120a (for example, inter-UE CLI). Additionally, or alternatively, the network node 110a may be subjected to CLI from the network node 110d (for example, inter-network-node CLI). Additionally, or alternatively, the UE 120a may experience self-interference as a result of the uplink transmission leaking into a port that receives the downlink transmission to the UE 120a.

In examples 500, 505, and/or 510, the UE 120a and/or the UE 120e may be configured with a full-duplex configuration, such as an SBFD configuration or an IBFD configuration. In some examples, the UE 120a and/or the UE 120e may be configured with an SBFD configuration 515 that contains uplink sub-band 520 and downlink sub-bands 525. The uplink sub-band 520 and the downlink sub-bands 525 may be arranged, in the same slot, within a component carrier (CC) bandwidth in a non-overlapping manner in the frequency domain. For example, the UE 120a may transmit the uplink transmission on the uplink sub-band 520, and the UE 120e may receive the downlink transmission on one or more of the downlink sub-bands 525.

In some examples, the UE 120a and/or the UE 120e may be configured with an IBFD configuration that contains partially-overlapping or fully-overlapping uplink resources and downlink resources. IBFD configurations 530 and 535 show example arrangements of partially-overlapping uplink resources 540 and downlink resources 545. In IBFD configuration 530, the highest frequency of the uplink resources 540 is less than the highest frequency of the downlink resources 545, and in IBFD configuration 535, the highest frequency of the uplink resources 540 is greater than the highest frequency of the downlink resources 545 In some examples, the UE 120a may be configured with an SBFD slot that contains the uplink resources 540 and the downlink resources 545. For example, the UE 120a may transmit the uplink transmission on the uplink resources 540, and the UE 120a and/or the UE 120e may receive the downlink transmissions on the downlink resources 545.

An SBFD operation may increase an uplink duty cycle, which may result in a latency reduction (for example, a downlink signal may be received in uplink-only slots, which may enable latency savings) and uplink coverage improvement. Additionally, or alternatively, the SBFD operation may improve a system capacity, resource utilization, and/or spectrum efficiency. Additionally, or alternatively, the SBFD operation may enable a flexible and dynamic uplink/downlink resource adaptation according to uplink/downlink traffic in a robust manner.

As shown by examples 500, 505, and 510, full duplex operation may lead to inter-network-node CLI. In some examples, uplink resource muting may be used to support an inter-network-node CLI measurement. For example, uplink resource muting may be used to measure spatial characteristics of network-node-to-network-node CLI caused by various downlink signals and thereby avoid CLI.

For example, a first network node (e.g., a victim network node) may receive a CLI reference signal from a second network node (e.g., an aggressor network node). The first network node may measure the CLI reference signal in order to determine a CLI level caused by the second network node. In order to accurately measure the CLI reference signal to obtain the CLI level, the first network node may mute an uplink transmission from a UE associated with the first network node, such that an entire uplink channel at a given time is dedicated for measuring the CLI reference signal. The uplink transmission may be muted when a timing of the uplink transmission corresponds to a timing of the CLI reference signal. The UE and the first network node may be associated with a same cell. When the uplink transmission is not muted, an accuracy of a CLI reference signal measurement may be degraded, which may result in a less accurate measurement of the CLI level. A muting of the uplink transmission may be referred to as an uplink resource muting, such that certain uplink resources are not used for the uplink transmission in order to improve a measurement accuracy of the CLI reference signal. The uplink resource muting may be a non-transparent uplink resource muting, in which case the uplink resource muting is known to the UE.

For a network-node-to-network-node co-channel CLI measurement and/or channel measurement (for example, gNB-to-gNB co-channel CLI measurement and/or channel measurement), an uplink resource muting may be based at least in part on transparent uplink resource muting or non-transparent uplink resource muting. Transparent uplink resource muting may involve avoiding scheduling transmissions on a measurement resource. Non-transparent uplink resource muting may involve defining an uplink resource muting pattern with one or more RE or RB muting patterns.

The uplink resource muting for the network-node-to-network-node co-channel CLI measurement and/or channel measurement may be used to measure a network-node-to-network-node (for example, gNB-to-gNB) CLI level with less interference from an uplink resource. The uplink resource muting may be used to measure a network-node-to-network-node channel with less interference from an uplink resource. The uplink resource muting may be used to measure a network-node-to-network-node CLI interference covariance matrix with less interference from an uplink resource. Transparent uplink resource muting may be supported using network node scheduling. The uplink resource muting may incur an uplink performance loss. A UE complexity and a potential increased peak-to-average power ratio (PAPR) impact of non-contiguous uplink transmissions may be considered when introducing non-transparent uplink resource muting.

Non-transparent uplink resource muting may enable a network-node-to-network-node co-channel CLI handling scheme by enabling network-node-to-network-node co-channel CLI and/or channel measurement. In some examples, non-transparent uplink resource muting may involve non-transparent uplink resource muting patterns at the RE-level or RB-level muting patterns, such as a comb-2 RE-level or RB-level muting pattern for PUSCH. “Comb-2” or “comb type 2” muting pattern refers to a pattern in which every second unit in the frequency domain (e.g., RE or RB) is muted during time resources in which the resource muting is to be applied.

A non-transparent uplink resource muting pattern may impact power control on symbols with RE-level uplink resource muting and/or uplink UCI bit mapping. Furthermore, non-transparent uplink resource muting may involve an indication of the non-transparent uplink resource muting pattern, impact PUSCH rate-matching and power allocation, or collision-handling with DMRS and/or phase tracking reference signal (PTRS), among other examples. In some examples, rate-matching may refer to techniques for mapping signals to resources (for example, time and/or frequency resources) around (for example, by avoiding) select resources.

Additionally, or alternatively, the network-node-to-network-node co-channel CLI handling scheme may involve an information exchange associated with a channel measurement; reference signals for the channel measurement; an information exchange associated with a measurement resource configuration (for example, a non-zero-power (NZP) CSI-RS or a non-cell-defining synchronization signal block (NCD-SSB), among other examples); an information exchange associated with a downlink beam indication; or an information exchange of preferred or restricted downlink beam information and associated resource configuration; among other examples.

Non-transparent uplink resource muting based interference rejection combining (IRC) with one symbol of uplink overhead and one symbol of downlink overhead may have: a similar mean downlink average user perceived throughput (UPT) for low load levels and medium load levels; a lower mean downlink average UPT for high load levels; a higher or similar 5% downlink average UPT for all load levels; and/or a higher mean uplink average UPT and a similar 5% uplink average UPT for all load levels.

A network-node-to-network-node co-channel CLI handling scheme (for example, a scheme where network-node-to-network-node co-channel CLI and/or channel measurement is used as an enabler for spatial-domain-based schemes) may help to suppress leakage interference, may increase PAPR for DFT-s-OFDM for certain uplink resource muting patterns, and may increase UE implementation complexity (for example, rate matching or power allocation, among other examples).

As indicated above, FIG. 5 is provided as an example. Other examples may differ from what is described with respect to FIG. 5.

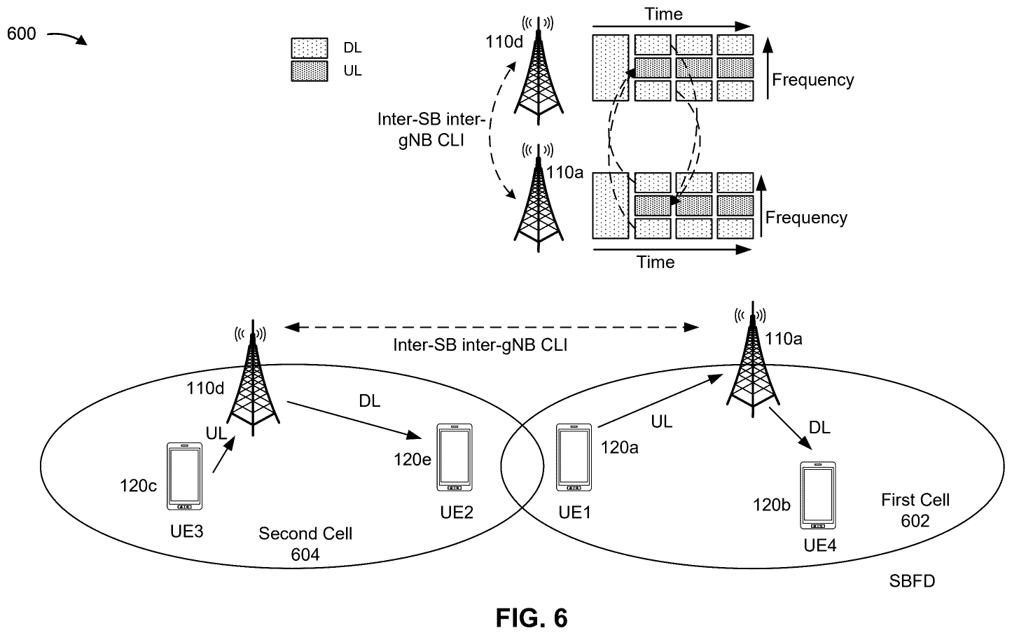

FIG. 6 is a diagram illustrating an example 600 of CLI.

As shown in FIG. 6, in an SBFD scenario, a first network node 110a in a first cell 602 may receive an uplink transmission from a first UE 120a in the first cell 602. The first network node 110a may transmit a downlink transmission to a fourth UE 120b in the first cell 602. A second network node 110d in a second cell 604 may receive an uplink transmission from a third UE 120c in the second cell 604. The second network node 110d may transmit a downlink transmission to a second UE 120e in the second cell 604. The first network node 110a may cause an inter-subband (SB) inter-network-node CLI to the second network node 110d, and vice versa. Downlink transmissions of the first network node 110a may cause the inter-SB inter-network-node (e.g., inter-gNB) CLI with an uplink transmission of the second network node 110d. Downlink transmissions of the second network node 110d may cause the inter-SB inter-network-node CLI with an uplink transmission of the first network node 110a.

A first network node (e.g., a victim network node) may receive a CLI reference signal from a second network node (e.g., an aggressor network node). The first network node may measure the CLI reference signal in order to determine a CLI level caused by the second network node. The CLI reference signal may be an NZP CSI-RS or a synchronization signal block (SSB). In order to accurately measure the CLI reference signal to obtain the CLI level, the first network node may mute an uplink transmission from a UE associated with the first network node, such that an entire uplink channel at a given time is dedicated for measuring the CLI reference signal. The uplink transmission may be muted when a timing of the uplink transmission corresponds to a timing of the CLI reference signal. The UE and the first network node may be associated with a same cell. When the uplink transmission is not muted, an accuracy of a CLI reference signal measurement may be degraded, which may result in a less accurate measurement of the CLI level.

The CLI reference signal may be periodic, and during a periodic occasion of a CLI reference signal transmission, an uplink resource may be muted. An uplink resource that is muted should not be used by the UE to perform the uplink transmission. In other words, the UE may refrain from performing the uplink transmission using the muted uplink resource, and instead may wait until a non-muted uplink resource is available to perform the uplink transmission.

For a network-node-to-network-node co-channel CLI measurement and/or channel measurement (e.g., inter-gNB CLI channel measurements/reporting), the uplink resource muting may be based at least in part on a transparent uplink resource muting or a non-transparent uplink resource muting. The uplink resource muting may be transparent to the UE, and may be based at least in part on a first network node scheduling. Alternatively, the first network node may cancel particular uplink resources. For example, the first network node may cancel particular RBs of a symbol or an entire symbol for the purpose of CLI reference signal measurement. The non-transparent uplink resource muting may be associated with a new uplink muting pattern. With the new uplink muting pattern, the UE may be aware of particular uplink resources that are muted, and the UE may not use those particular uplink resources for the uplink transmission. The particular uplink resources may correspond to the CLI reference signal in a time domain. The UE may be able to use remaining uplink resources for the uplink transmission because the remaining uplink resources may not conflict with the CLI reference signal.

The uplink resource muting may be used to measure a network-node-to-network-node (e.g., gNB-to-gNB) CLI level with less interference from an uplink resource. The uplink resource muting may be used to measure a network-node-to-network-node channel with less interference from an uplink resource. The uplink resource muting may be used to measure a network-node-to-network-node CLI interference covariance matrix with less interference from an uplink resource. The network-node-to-network-node CLI interference covariance matrix may be associated with a channel estimation.

In some examples, an uplink resource muting pattern may be applicable for up to M time intervals within N time intervals (e.g., where N is greater than or equal to M). As used herein, “time interval” refers to a period of time defined or otherwise configured for wireless communication. For example, a time interval may include a frame, a subframe, a slot, a mini-slot, multiple OFDM symbols, a single OFDM symbol, a TTI, a time domain resource allocation, a scheduling unit, a time unit, or another time interval. For example, the time intervals may be defined in accordance with a frame structure for wireless communication. A transmission timeline for each of the downlink and uplink may be partitioned into units of radio frames (sometimes referred to as frames). Each radio frame may have a predetermined duration (e.g., 10 milliseconds (ms)) and may be partitioned into a set of Z (Z≥1) subframes. Each subframe may have a predetermined duration (e.g., 1 ms) and may include a set of slots (e.g., 2m slots per subframe are, where m is an index of a numerology used for a transmission, such as 0, 1, 2, 3, 4, or another number). Each slot may include a set of L symbol periods (e.g., L OFDM symbols). For example, each slot may include fourteen symbol periods, seven symbol periods, or another number of symbol periods. In some aspects, a scheduling unit may be frame-based, subframe-based, slot-based, mini-slot based, or symbol-based.

As an example, the M time intervals may be M OFDM symbols and the N time intervals may include a slot or a time domain resource allocation for a given channel (e.g., a PUSCH time domain resource allocation). For example, a value of M may be greater than one, such as two, three, or another quantity. An uplink resource muting pattern may be applicable for all allocated RBs and up to M time intervals in the time domain (e.g., for all allocated RBs and up to 2 OFDM symbols in the time domain).

However, it may be unclear or undefined which M time intervals within N time intervals are to be associated with the uplink resource muting pattern. For example, in non-transparent uplink resource muting, a network node may transmit, and the UE may receive, an indication that the uplink resource muting pattern is to be applied. The uplink resource muting pattern may indicate which resources are to be muted in the frequency domain (e.g., a comb-2 pattern may indicate that every second RE or RB is to be muted in the frequency domain). However, the uplink resource muting pattern may not indicate which time domain resources (e.g., which M time intervals) during which the uplink resource muting pattern is to be applied. As a result, the UE may apply the uplink resource muting pattern during a time interval (e.g., an OFDM symbol or another time interval) that is not expected or intended by the network node. This may degrade CLI measurement performance by the network node because the UE may transmit uplink signal(s) during time-frequency resources in which the network node is measuring a CLI reference signal. Additionally, this may increase latency and/or decrease throughput for the UE because the UE may incorrectly refrain from transmitting uplink signal(s) during the muted resources that would otherwise be available for use by the UE.

Further, one or more reference signals may be configured to occur during some time intervals. For example, one or more DMRSs, PTRSs, and/or other reference signals may be configured to be transmitted by the UE during some time intervals (e.g., during some OFDM symbols). If the UE applies the resource muting pattern to time-frequency resources during which a reference signal is configured to be transmitted, the UE may refrain from transmitting the reference signal. This may degrade communication performance between the UE and the network node if the network node expects that the reference signal is to be transmitted. For example, the network node may attempt to receive and/or measure the reference signal. However, if the UE does not transmit the reference signal in accordance with the resource muting pattern, then the network node may needlessly consume processing resources associated with attempting to receive, measure, and/or otherwise process the reference signal. Additionally, or alternatively, the network node may identify that a measurement of the reference signal is low or zero (e.g., because the UE does not actually transmit the reference signal when expected by the network node), resulting in the network node needlessly performing one or more actions based on, or in response to, the identified low measurement of the reference signal.

As indicated above, FIG. 6 is provided as an example. Other examples may differ from what is described with regard to FIG. 6.

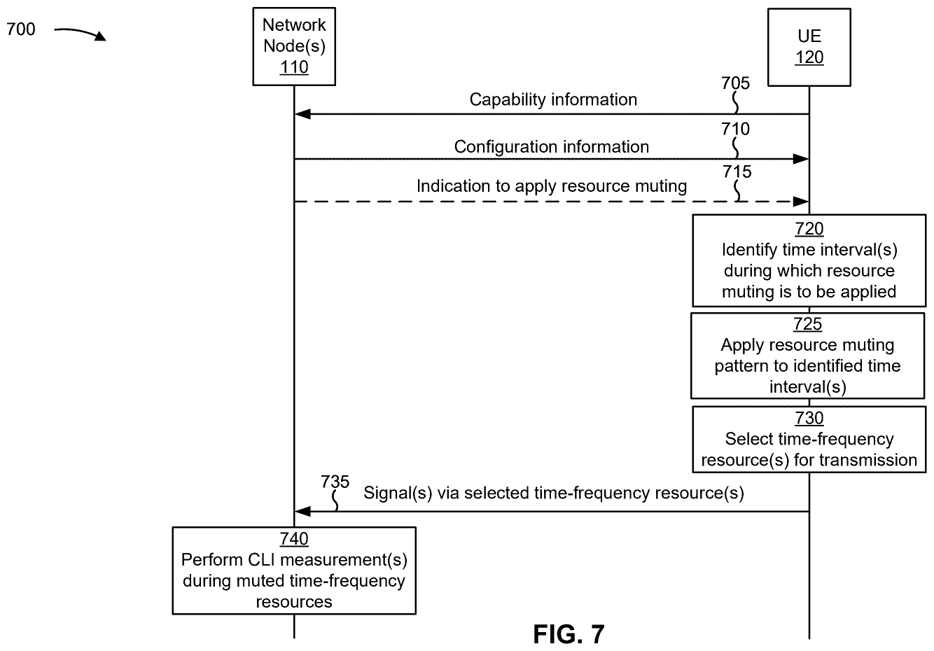

FIG. 7 is a diagram of an example 700 associated with resource muting patterns. As shown in FIG. 7, a network node 110 (e.g., a base station, a CU, a DU, and/or an RU) may communicate with a UE 120. In some aspects, the network node and the UE may be part of a wireless network (e.g., the wireless communication network 100). The UE 120 and the network node 110 may have established a wireless connection prior to operations shown in FIG. 7. The network node 110 may be operating in a full-duplex mode, such as described in connection with FIGS. 4-6. For example, the network node 110 may be operating in an SBFD mode or another full-duplex mode.

As shown by reference number 705, In some aspects, the UE 120 may transmit, and the network node 110 may receive, capability information. The capability information may be included in a capability report. The UE 120 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a PSCCH, and/or a PSSCH, among other examples. The capability information may indicate one or more parameters associated with respective capabilities of the UE 120. The one or more parameters may be indicated via respective information elements (IEs) included in a capability report.

The capability information may indicate whether the UE 120 supports a feature and/or one or more parameters related to the feature. For example, the capability information may indicate a capability and/or parameter for resource muting (e.g., uplink resource muting). As another example, the capability information may indicate a capability and/or parameter for non-transparent resource muting. One or more operations described herein may be based on capability information. For example, the UE 120 may perform a communication in accordance with the capability information, or may receive configuration information that is in accordance with the capability information.

In some aspects, the capability information may indicate UE 120 support for applying resource muting in accordance with resource muting pattern (e.g., an uplink resource muting pattern). In some aspects, the capability information may indicate UE 120 support for receiving a configuration of a resource muting pattern (e.g., an uplink resource muting pattern). In some aspects, the capability information may indicate UE 120 support for one or more types of resource muting patterns, such as a comb-2 resource muting pattern, a comb-4 resource muting pattern, or another type of resource muting pattern. The capability information may indicate whether the UE 120 supports one or more RB-level uplink resource muting patterns or one or more RE-level uplink resource muting patterns. The capability information may indicate UE 120 support for applying resource muting during time intervals (e.g., OFDM symbols or other time intervals) that are configured with one or more types of reference signals (e.g., uplink reference signals). For example, the capability information may indicate whether the UE 120 supports applying uplink resource muting for an OFDM symbol that is configured with a DMRS. As another example, the capability information may indicate whether the UE 120 supports applying uplink resource muting for an OFDM symbol that is configured with a PTRS.

In some aspects, the capability information may indicate a quantity of time intervals (e.g., OFDM symbols) that the UE 120 supports applying resource muting during a given time interval or time period. For example, the capability information may indicate a quantity of OFDM symbols (e.g., one OFDM symbol, two OFDM symbols, or another quantity of OFDM symbols) for which the UE 120 can apply resource muting during a given slot, subframe, and/or time domain resource allocation, among other examples.

The network node 110 may determine configuration information and/or a resource muting pattern for the UE 120 based at least in part on, or otherwise associated with, the capability information. For example, the network node 110 may determine a quantity of time intervals (e.g., a quantity of OFDM symbols) during which the UE 120 is to apply the resource muting pattern in a given slot, subframe, and/or time domain resource allocation, among other examples, to be less than or equal to the supported quantity of OFDM symbols indicated via the configuration information. As another example, the network node 110 may determine whether the uplink resource muting pattern is to be applied during an OFDM symbol that is configured with a reference signal (e.g., a DMRS, a PTRS, or another reference signal) based at least in part on, or otherwise associated with, whether the capability information indicates that the UE 120 supports applying the resource muting pattern during OFDM symbols that are configured with the reference signal. Additionally, or alternatively, the network node 110 may determine the configuration information and/or a resource muting pattern for the UE 120 without (e.g., independent of) the capability information, such as by using one or more rules or parameters defined, or otherwise fixed, by a wireless communication standard (e.g., the 3GPP).

As shown by reference number 710, the network node 110 may transmit, and the UE 120 may receive, configuration information. In some aspects, the UE may receive the configuration information via one or more of system information signaling (e.g., a master information block (MIB) and/or a system information block (SIB), among other examples), RRC signaling, MAC signaling (e.g., one or more MAC-CEs), and/or DCI signaling, among other examples.

In some aspects, the UE 120 may receive the configuration from the network node 110, as shown in FIG. 5. Additionally, or alternatively, the UE 120 may obtain the configuration from memory, such as from a configuration stored by the UE 120. For example, as used herein, “obtaining” the configuration information may refer to the UE 120 receiving (e.g., via over-the-air signaling) the configuration information and/or obtaining the configuration information from memory. For example, at least a portion (or all) of the configuration information described herein may be defined, or otherwise fixed, by a wireless communication standard, such as the 3GPP. In such examples, the UE 120 may store the configuration information, such as in an original equipment manufacturer (OEM) configuration or another stored configuration. This may be referred to as the configuration information being “hard coded” for the UE 120. In such examples, the configuration information may not be signaled to the UE 120 via over-the-air signaling. Instead, the UE 120 may obtain the configuration information from memory. In some aspects, the UE 120 may obtain a first portion of the configuration information described herein from the network node 110 (e.g., via over-the-air signaling) and may obtain second portion of the configuration information by retrieving the second portion from memory (e.g., from an OEM configuration).

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

The configuration information may indicate that resource muting (e.g., uplink resource muting) is configured or enabled for the UE 120. For example, the configuration information may include a resource muting configuration. The resource muting configuration may indicate a resource muting pattern and/or one or more time intervals during which the UE 120 is to apply the resource muting pattern, as described in more detail elsewhere herein. For example, the configuration information may indicate that uplink resource muting is enabled for the UE 120 and that the UE 120 is to apply resource muting in accordance with the resource muting configuration. For example, the network node 110 may transmit, and the UE 120 may receive, RRC signaling indicating that uplink resource muting is enabled for the UE 120. The UE 120 may apply resource muting in accordance with the resource muting configuration based at least in part on, in response to, or otherwise associated with receiving the RRC signaling indicating that uplink resource muting is enabled for the UE 120. The UE 120 may continue to apply the resource muting until receiving additional signaling indicating that uplink resource muting is disabled for the UE 120. For example, uplink resource muting may be enabled for the UE 120 until disabled by additional RRC signaling from the network node 110.

In some aspects, the network node 110 may transmit, and the UE 120 may receive, multiple resource muting configurations (e.g., multiple candidate resource muting configurations). For example, the network node 110 may transmit, and the UE 120 may receive, RRC signaling indicating the multiple resource muting configurations. In such examples, the network node 110 may transmit, and the UE 120 may receive, an indication (e.g., a dynamic indication) activating or selecting a given resource muting configuration from the multiple resource muting configurations. The indication may be communicated via MAC signaling (e.g., one or more MAC-CEs) and/or DCI signaling, among other examples. The network node 110 may enable (e.g., activate or select) or disable (e.g., deactivate or deselect) a given resource muting configuration from the multiple resource muting configurations via MAC signaling (e.g., one or more MAC-CEs) and/or DCI signaling, among other examples. In some aspects, the network node 110 may transmit, and the UE 120 may receive, an indication that all of the multiple resource muting configurations are deactivated (e.g., indicating that uplink resource muting is disabled for the UE 120).

The configuration information may indicate a resource muting pattern. The resource muting pattern may be UE-transmission resource muting pattern (e.g., an uplink resource muting pattern, a sidelink resource muting pattern, or another type of resource muting pattern). The indication of the resource muting pattern may be periodic resource muting pattern indication, an aperiodic resource muting pattern indication, or a predefined resource muting pattern index, among other examples.

In some aspects, the indication associated with the resource muting may indicate the periodic resource muting pattern. The indication of the periodic resource muting pattern may indicate a time location associated with the resource, a frequency location associated with the uplink resource, and/or a periodicity associated with the uplink resource. Remaining uplink resource(s) that are not muted may be available for transmission by the UE 120. In some aspects, the UE 120 may receive, from the network node 110, the indication of the periodic resource muting pattern in a semi-static manner, such as via RRC signaling. Additionally, or alternatively, the UE 120 may receive, from the network node 110, the indication of the periodic resource muting pattern in a semi-persistent manner, such as via a MAC-CE communication.

In some aspects, the indication associated with the resource muting may indicate the aperiodic resource muting pattern. The indication of the aperiodic resource muting pattern may indicate a time location associated with the resource and/or a frequency location associated with the resource. The indication of the aperiodic resource muting pattern may indicate a quantity of slots in which to apply the aperiodic resource muting pattern and/or a time window during which to apply the aperiodic resource muting pattern. Remaining resource(s) that are not muted may be available for transmission by the UE 120. In some aspects, the UE 120 may receive, from the network node 110, the indication of the aperiodic resource muting pattern in a dynamic manner, such as via DCI. The DCI may include a dedicated field, a reserved field, or an unused field to indicate the aperiodic resource muting pattern. The DCI may be associated with a DCI format that schedules a dynamic transmission. The DCI may be associated with a DCI format that does not schedule data. The DCI may be a group common DCI.

In some aspects, the indication associated with the resource muting may indicate a predefined resource muting pattern index. The predefined resource muting pattern index may be associated with one resource muting pattern from multiple different uplink muting patterns with different time and frequency locations at which uplink resources are muted. The multiple different resource muting patterns may be defined, or otherwise fixed, by a wireless communication standard, such as the 3GPP. The UE 120 may receive, from the network node 110, the indication of the predefined resource muting pattern index via the configuration information.

In some aspects, the resource muting pattern is associated with a first one or more symbols, within a time interval associated with a set of resources, during which the resource muting pattern is to be applied. A duration of the time interval may be greater than a duration of a given time interval of the first one or more symbols. The first one or more symbols may be OFDM symbols or another time interval. The time interval may be a frame, a subframe, a slot, a mini-slot, a scheduling unit, a time domain resource allocation (e.g., a PUSCH time domain resource allocation, a PUCCH time domain resource allocation, or another time domain resource allocation allocated or configured for the UE 120), or another time interval. For example, the resource muting pattern may indicate time-frequency resources within a given time interval of the first one or more time intervals that are to be muted (e.g., given REs or RBs in a given OFDM symbol that are to be muted). The configuration information may indicate which time interval(s) (e.g., which OFDM symbol(s)) during the time interval that the UE 120 is to apply the resource muting pattern.

One or more positions of the first one or more time intervals is based at least in part on the time interval. For example, positions (e.g., in the time domain) of respective time intervals during which the UE 120 is to apply the resource muting pattern may be indicated relative to the time interval. For example, the one or more positions of the first one or more time intervals are indicated (e.g., by the configuration information) relative to a start of the time interval. Additionally, or alternatively, the configuration information may indicate that the one or more positions of the first one or more time intervals are indicated (e.g., by the configuration information) relative to an end of the time interval. The start of the time interval may refer to a first (e.g., in time) time interval (e.g., a first OFDM symbol) within the time interval that is configured for full-duplex operation (e.g., that is configured for SBFD operation). For example, the time interval may include one or more full-duplex time intervals (e.g., one or more SBFD time intervals) and one or more non-full-duplex time intervals (e.g., one or more non-SBFD time intervals). The “start” of the time interval refers to the full-duplex time interval that occurs first in the time domain within the time interval. The “end” of the time interval refers to the full-duplex time interval that occurs last in the time domain within the time interval. In other words, any non-full-duplex time intervals within the time interval may not be considered when identifying the start and the end of the time interval, as described herein.

The configuration information may indicate a quantity of time intervals to be included in the first one or more time intervals. For example, the configuration information may indicate that the UE 120 is to apply resource muting during one (e.g., a single) time interval (e.g., one OFDM symbol) during the time interval. As another example, the configuration information may indicate that the UE 120 is to apply resource muting during two time intervals (e.g., two OFDM symbols) during the time interval.

In some aspects, the configuration information may indicate the position(s) of the first one or more time intervals (e.g., an explicit indication of the time domain positions within the time interval). In some other aspects, the configuration information may indicate one or more rules to be used by the UE 120 to determine the time domain positions of the first one or more time intervals within the time interval. For example, the one or more rules may be defined, or otherwise fixed, by a wireless communication standard, such as the 3GPP.

The time interval may be a time domain resource allocation, such as for the PUSCH, among other examples. The configuration information may indicate the time domain resource allocation. For example, a channel configuration (e.g., a PUSCH configuration) may indicate the time domain resource allocation for the channel. Additionally, or alternatively, the time domain resource allocation may be indicated via additional signaling from the network node 110, such as via one or more MAC-CEs or

DCI. In examples where the first one or more time intervals include a single time interval (e.g., a single OFDM symbol), the configuration information may indicate that the position of the single time interval is relative to a start of the time domain resource allocation or an end of the time domain resource allocation. For example, the configuration information may indicate that UE 120 is to apply resource muting during the Kth OFDM symbol (e.g., that is configured for full-duplex operation) of the time domain resource allocation relative to the start of the time domain resource allocation (e.g., relative to a first OFDM symbol in time that is configured for full-duplex operation). As another example, the configuration information may indicate that the UE 120 is to apply resource muting during the Kth OFDM symbol (e.g., that is configured for full-duplex operation) of the time domain resource allocation relative to the end of the time domain resource allocation (e.g., relative to a last OFDM symbol in time that is configured for full-duplex operation). As another example, a rule may indicate that the UE 120 is to apply resource muting during the Kth OFDM symbol (e.g., that is configured for full-duplex operation) of the time domain resource allocation relative to the start or the end of the time domain resource allocation.

In examples where the first one or more time intervals include multiple time intervals (e.g., two time intervals, such as two OFDM symbols), the configuration information may indicate that positions of respective time intervals of the multiple time intervals are relative to the start of the time domain resource allocation and/or the end of the time domain resource allocation. In some aspects, the multiple time intervals may be consecutive or contiguous in the time domain. In other examples, the multiple time intervals may not be consecutive or contiguous in the time domain (e.g., there may be a gap in the time domain between the multiple time intervals). As an example, the configuration information may indicate that UE 120 is to apply resource muting during the Kth OFDM symbol and the Lth OFDM symbol (e.g., that are configured for full-duplex operation) of the time domain resource allocation relative to the start of the time domain resource allocation (e.g., relative to a first OFDM symbol in time that is configured for full-duplex operation). For example, the configuration information may indicate that the resource muting pattern is to be applied during the first and second (e.g., in time) full-duplex time intervals within the time domain resource allocation. As another example, the configuration information may indicate that the UE 120 is to apply resource muting during the Kth OFDM symbol and the Lth OFDM symbol (e.g., that are configured for full-duplex operation) of the time domain resource allocation relative to the end of the time domain resource allocation (e.g., relative to a last OFDM symbol in time that is configured for full-duplex operation). For example, the configuration information may indicate that the resource muting pattern is to be applied during the last and second to last (e.g., in time) full-duplex time intervals within the time domain resource allocation. As another example, the configuration information may indicate that the UE 120 is to apply resource muting during the Kth OFDM symbol relative to the start of the time domain resource allocation and to the Lth OFDM symbol relative to the end of the time domain resource allocation. For example, the configuration information may indicate that the resource muting pattern is to be applied during the first and last (e.g., in time) full-duplex time intervals within the time domain resource allocation.

As another example, the time interval may be a subframe, a slot, or a mini-slot, among other examples. In examples where the first one or more time intervals include a single time interval (e.g., a single OFDM symbol), the configuration information may indicate that the position of the single time interval is relative to a start of the subframe, the slot, or the mini-slot or an end of the subframe, the slot, or the mini-slot. For example, the configuration information may indicate that UE 120 is to apply resource muting during the Kth OFDM symbol (e.g., that is configured for full-duplex operation) of the subframe, the slot, or the mini-slot relative to the start of the subframe, the slot, or the mini-slot (e.g., relative to a first OFDM symbol in time that is configured for full-duplex operation). As another example, the configuration information may indicate that the UE 120 is to apply resource muting during the Kth OFDM symbol (e.g., that is configured for full-duplex operation) of the subframe, the slot, or the mini-slot relative to the end of the subframe, the slot, or the mini-slot (e.g., relative to a last OFDM symbol in time that is configured for full-duplex operation). As another example, a rule may indicate that the UE 120 is to apply resource muting during the Kth OFDM symbol (e.g., that is configured for full-duplex operation) of the subframe, the slot, or the mini-slot relative to the start or the end of the subframe, the slot, or the mini-slot.

In examples where the first one or more time intervals include multiple time intervals (e.g., two time intervals, such as two OFDM symbols), the configuration information may indicate that positions of respective time intervals of the multiple time intervals are relative to the start of the subframe, the slot, or the mini-slot and/or the end of the subframe, the slot, or the mini-slot. As an example, the configuration information may indicate that UE 120 is to apply resource muting during the Kth OFDM symbol and the Lth OFDM symbol (e.g., that are configured for full-duplex operation) of the subframe, the slot, or the mini-slot relative to the start of the subframe, the slot, or the mini-slot (e.g., relative to a first OFDM symbol in time that is configured for full-duplex operation). For example, the configuration information may indicate that the resource muting pattern is to be applied during the first and second (e.g., in time) full-duplex time intervals within the subframe, the slot, or the mini-slot. As another example, the configuration information may indicate that the UE 120 is to apply resource muting during the Kth OFDM symbol and the Lth OFDM symbol (e.g., that are configured for full-duplex operation) of the subframe, the slot, or the mini-slot relative to the end of the subframe, the slot, or the mini-slot (e.g., relative to a last OFDM symbol in time that is configured for full-duplex operation). For example, the configuration information may indicate that the resource muting pattern is to be applied during the last and second to last (e.g., in time) full-duplex time intervals within the subframe, the slot, or the mini-slot. As another example, the configuration information may indicate that the UE 120 is to apply resource muting during the Kth OFDM symbol relative to the start of the subframe, the slot, or the mini-slot and to the Lth OFDM symbol relative to the end of the subframe, the slot, or the mini-slot. For example, the configuration information may indicate that the resource muting pattern is to be applied during the first and last (e.g., in time) full-duplex time intervals within the subframe, the slot, or the mini-slot.

In some aspects, the configuration information may indicate whether time intervals (e.g., OFDM symbols) that are configured with one or more types of reference signals are to be used for resource muting. The configuration information may indicate whether the resource muting pattern is to include time intervals associated with a given reference signal (e.g., time intervals that during which the reference signal is configured to occur). For example, the configuration information may indicate whether the UE 120 is to apply the resource muting pattern during time intervals (e.g., OFDM symbols) that are configured with one or more types of reference signals. The one or more types of reference signals may include a DMRS, a PTRS, an uplink reference signal, and/or another type of reference signal.

In some aspects, whether the time intervals (e.g., OFDM symbols) that are configured with one or more types of reference signals are to be used for resource muting may be based at least in part on, or otherwise associated with, the time interval. For example, whether the time intervals (e.g., OFDM symbols) that are configured with one or more types of reference signals are to be used for resource muting may be based at least in part on, or otherwise associated with, a size of the time interval. The size may include a quantity of time intervals (e.g., OFDM symbols) within the time interval that are configured for full-duplex operation (e.g., SBFD operation). As an example, if the size of the time interval does not satisfy a threshold, then the time intervals (e.g., OFDM symbols) that are configured with one or more types of reference signals are to be used for resource muting (e.g., and the UE 120 may apply the resource muting pattern during time intervals that are configured with one or more types of reference signals). If the size of the time interval does satisfy the threshold, then the time intervals (e.g., OFDM symbols) that are configured with one or more types of reference signals are not to be used for resource muting (e.g., and the UE 120 may refrain from applying the resource muting pattern during time intervals that are configured for use for the reference signal). In some aspects, a value of the threshold may be indicated via the configuration information (e.g., and determined by the network node 110).

As another example, whether the time intervals (e.g., OFDM symbols) that are configured with one or more types of reference signals are to be used for resource muting may be based at least in part on, or otherwise associated with, a quantity of full-duplex time intervals (e.g., full-duplex OFDM symbols or SBFD OFDM symbols) within the time interval that are not configured with the one or more types of reference signals. For example, the configuration information may indicate that the time intervals (e.g., OFDM symbols) that are configured with one or more types of reference signals are to be used for resource muting only if there are no other available full-duplex time intervals in the time interval. For example, the configuration information may indicate that OFDM symbols configured with a given reference signal (e.g., a DMRS, a PTRS, or another reference signal) are to be used for resource muting when OFDM symbols (e.g., without the given reference signal) within a time domain resource allocation are not available. The first one or more time intervals may include one or more time intervals during which a reference signal (e.g., a DMRS, a PTRS, or another reference signal) is configured to occur based at least in part on the time domain resource allocation not including available time intervals without the reference signal.

In some aspects, a given reference signal may be associated with a configuration type. For example, a DMRS may be associated with a configuration type 1, a configuration type 2, or another configuration type defined, or otherwise fixed, by a wireless communication standard, such as the 3GPP. A configuration type of a DMRS may indicate resource allocation information for the DMRS. As an example, a configuration type may indicate a minimum size of a resource element group for the DMRS in the frequency domain. For example, the DMRS configuration type 1 may indicate a minimum resource element group of one RE in the frequency domain and the DMRS configuration type 2 may indicate a minimum resource element group of two REs in the frequency domain. In some aspects, whether the time intervals (e.g., OFDM symbols) that are configured with one or more types of reference signals are to be used for resource muting may be based at least in part on, or otherwise associated with the configuration type being compatible with the resource muting pattern. As used herein, a configuration type is “compatible” with a resource muting pattern if both the reference signal (e.g., in accordance with the configuration type) and the resource muting pattern can be configured during the same time interval without occupying the same frequency domain resources. This ensures that the resource muting pattern does not impact the performance of the reference signal because time-frequency resource associated with the reference signal may not be muted even if the resource muting pattern is applied during a time interval (e.g., an OFDM symbol) during which the reference signal is configured to be transmitted.

As an example, the DMRS configuration type 1 may be compatible with a comb-2 resource muting pattern because the comb-2 resource muting pattern mutes every second RE in the frequency domain and the DMRS configuration type 1 is associated with a minimum resource element group of one RE in the frequency domain (e.g., meaning that the DMRS may occupy every other RE with other REs being muted). However, the DMRS configuration type 2 may not be compatible with a comb-2 resource muting pattern because the DMRS configuration type 2 is associated with a minimum resource element group of two REs. This results in the comb-2 resource muting pattern muting at least one of the two consecutive REs allocated for the DMRS in the frequency domain because the comb-2 resource muting pattern may mute every second (or every other) RE. Therefore, a comb-2 resource muting pattern may be applicable to time intervals (e.g., OFDM symbols) during which a DMRS having the DMRS configuration type 1 is configured (e.g., for an uplink channel, such as the PUSCH). The comb-2 resource muting pattern may not be applicable to time intervals (e.g., OFDM symbols) during which a DMRS having the DMRS configuration type 2 is configured (e.g., for an uplink channel, such as the PUSCH).

In some aspects, a reference signal may be configured with one or more code division multiplexing (CDM) groups. For a given scheduled communication (e.g., a scheduling PUSCH communication), at least one CDM group may be allocated for a reference signal, such as a DMRS. Whether the time intervals (e.g., OFDM symbols) that are configured with one or more types of reference signals are to be used for resource muting may be based at least in part on, or otherwise associated with at least one CDM group not being allocated for the reference signal, such as a DMRS. The configuration information may indicate that the resource muting pattern may be applicable to a scheduled communication based at least in part on at least one CDM group, of multiple CDM groups configured for the reference signal, not being allocated for the scheduled communication. For example, a DMRS may be configured with a first CDM group and a second CDM group. Scheduling information (e.g., DCI or RRC information for a periodic communication) for a communication may indicate which CDM group(s) are allocated for the communication. If only one CDM group (e.g., the first CDM group or the second CDM group, but not both) is allocated for the DMRS for the communication, then the resource muting pattern may be applicable to the communication, as described herein.

However, if all CDM groups (e.g., the first CDM group and the second CDM group) are allocated for the DMRS for the communication, then the resource muting pattern may not be applicable to the communication. In such examples, the UE 120 may transmit the communication (e.g., one or more PUSCH communications) without applying the resource muting pattern. As another example, if the resource muting pattern is configured for the communication (e.g., one or more PUSCH communications) and all CDM groups (e.g., the first CDM group and the second CDM group) are allocated for the DMRS for the communication, then the UE 120 may refrain from transmitting (e.g., may drop) the communication. For example, the UE 120 may expect that an uplink channel (e.g., the PUSCH) should be scheduled with the DMRS allocated to less than all configured CDM groups for the DMRS (e.g., to only one CDM group for the DMRS). If the uplink channel (e.g., the PUSCH) for which the uplink resource muting pattern is configured is scheduled with all configured CDM groups for the DMRS, then the UE 120 may treat the occurrence (e.g., the scheduling) as an error case and may drop the scheduled uplink channel communication(s).

In some aspects, the configuration information may indicate that time intervals (e.g., OFDM symbols) during which a reference signal is configured are to be excluded from resource muting (e.g., from resource muting determinations). For example, the configuration information may indicate that time intervals (e.g., OFDM symbols) during which a PTRS is configured to be transmitted are to be excluded from resource muting. In such examples, the resource muting pattern may be applicable to an uplink channel (e.g., the PUSCH) based at least in part on, or otherwise associated with, a quantity of time intervals (e.g., a quantity of OFDM symbols) within the second time interval that are not configured with the reference signal (e.g., with the DMRS or the PTRS) satisfying a threshold. For example, the resource muting pattern may be applicable to an uplink channel (e.g., the PUSCH) based at least in part on, or otherwise associated with, a quantity of time intervals (e.g., a quantity of OFDM symbols) within the second time interval that are not configured with the reference signal (e.g., with the DMRS or the PTRS) being greater than or equal to the quantity of time intervals (e.g., OFDM symbols) during which the resource muting pattern is to be applied. For example, if the configuration information indicates that the resource muting pattern is to be applied during two OFDM symbols, then the resource muting pattern may be applicable to an uplink channel (e.g., the PUSCH) based at least in part on, or otherwise associated with, the second time interval including at least two symbols that are not configured with the reference signal (e.g., the DMRS or the PTRS).

For example, the UE 120 may expect that the quantity of OFDM symbols within the second time interval that are not configured with the reference signal (e.g., the DMRS or the PTRS) is greater than or equal to (e.g., not less than) the quantity of OFDM symbols during which the resource muting pattern is to be applied (e.g., the quantity of muting symbols). In some aspects, the configuration information may indicate that the resource muting pattern is not applicable to the uplink channel (e.g., the PUSCH) if the quantity of OFDM symbols within the second time interval that are not configured with the reference signal (e.g., the DMRS or the PTRS) is less than the quantity of OFDM symbols during which the resource muting pattern is to be applied. In such examples, the UE 120 may transmit one or more signals (e.g., one or more PUSCH communications) without applying the resource muting pattern (e.g., even if the resource muting pattern is configured). In other words, the UE 120 may drop or not apply resource muting if the quantity of OFDM symbols within the second time interval that are not configured with the reference signal (e.g., the DMRS or the PTRS) is less than the quantity of OFDM symbols during which the resource muting pattern is to be applied. As another example, if the quantity of OFDM symbols within the second time interval that are not configured with the reference signal (e.g., the DMRS or the PTRS) is less than the quantity of OFDM symbols during which the resource muting pattern is to be applied, then the UE 120 may consider such an occurrence to be an error case. In some aspects, the UE 120 may refrain from transmitting (e.g., may drop) the communication(s) if the quantity of OFDM symbols within the second time interval that are not configured with the reference signal (e.g., the DMRS or the PTRS) is less than the quantity of OFDM symbols during which the resource muting pattern is to be applied.

In some aspects, a configuration parameter of the reference signal may indicate which frequency domain resources are allocated or configured for the reference signal. For example, the configuration parameter may be an RE reference parameter, such as

$${k}_{ref}^{R E}$$

for a PTRS (e.g., as defined, or otherwise fixed, by a wireless communication standard, such as the 3GPP). For example, the RE reference parameter may indicate whether the PTRS is to be transmitted in REs having an even index value, REs having an odd index value, or REs having both even index values and odd index values. The configuration information may indicate that the resource muting pattern is applicable to a channel based at least in part on, or otherwise associated with, the configuration parameter (e.g., the

$${k}_{r e f}^{R E}$$

parameter for a PTRS) indicating that the reference signal is to be transmitted via either REs having an even index value or REs having an odd index value, but not both. The configuration information may indicate that if the configuration parameter (e.g., the

$${k}_{r e f}^{R E}$$

parameter for a PTRS) indicating that the reference signal is to be transmitted via REs having both even index values and odd index values, then the resource muting pattern may not be applicable for the uplink channel (e.g., for one or more communications to be transmitted by the UE 120). In such examples, the UE 120 may transmit the one or more communications without applying the resource muting pattern. As another example, the UE 120 may refrain from transmitting (e.g., may drop) the one or more communications. For example, if the resource muting pattern is configured and the configuration parameter (e.g., the

$${k}_{r e f}^{R E}$$

parameter for a PTRS) indicating that the reference signal is to be transmitted via REs having both even index values and odd index values, then the UE 120 may consider such an occurrence as an error case (e.g., and may drop any scheduled communications).

The UE 120 may configure itself based at least in part on the configuration information. In some aspects, the UE 120 may be configured to perform one or more operations described herein based at least in part on the configuration information.

In some aspects, the configuration information described in connection with reference number 710 and/or the capability information described in connection with reference number 705 may include information transmitted via multiple communications. Additionally, or alternatively, the network node 110 may transmit the configuration information, or a communication including at least a portion of the configuration information, before and/or after the UE 120 transmits the capability information. For example, the network node 110 may transmit a first portion of the configuration information before the UE 120 transmit the capability information, the UE 120 may transmit at least a portion of the capability information, and the network node 110 may transmit a second portion of the configuration information after receiving the capability information.

In some aspects, as shown by reference number 715, the network node 110 may transmit, and the UE 120 may receive, an indication to apply resource muting. For example, the resource muting pattern may be configured or enabled via the configuration information (e.g., described in connection with reference number 710). The network node 110 may transmit, and the UE 120 may receive, an indication to activate a configured resource muting pattern (e.g., from one or more configured resource muting patterns). The indication to apply resource muting may be a dynamic indication. For example, the indication apply resource muting may be communicated via MAC signaling (e.g., one or more MAC-CEs) and/or DCI signaling, among other examples. The indication to apply resource muting may indicate that the resource muting pattern is to be applied during the second time interval described elsewhere herein (e.g., during a given slot or for a given time domain resource allocation for a channel, such as a PUSCH time domain resource allocation).

As shown by reference number 720, the UE 120 may identify one or more time intervals (e.g., the first one or more time intervals described elsewhere herein) during which resource muting is to be applied. The UE 120 may identify the first one or more time intervals in accordance with the configuration information. For example, the UE 120 may identify, within the second time interval, positions of respective time intervals of the first one or more time intervals. As an example, the UE 120 may identify positions of OFDM symbol(s) within the second time interval (e.g., a slot or time domain resource allocation (e.g., a PUSCH time domain resource allocation or another time domain resource allocation)) during which the resource muting pattern is to be applied using the configuration information and/or rule(s).

For example, the configuration information may indicate that the resource muting pattern is to be applied in the K^{th} OFDM symbol and the L^{th} OFDM symbol (e.g., that are configured for full-duplex operation) of the time domain resource allocation relative to the start of the second time interval. The UE 120 may identify the start of the second time interval (e.g., may identify a first OFDM symbol in time that is configured for full-duplex operation within the second time interval). The UE 120 may count, from the start of the second time interval, K and L OFDM symbols to identify the OFDM symbols during which the resource muting pattern is to be applied.

In some aspects, the UE 120 may determine whether resource muting is to be applied during OFDM symbols that are configured with a reference signal, such as a DMRS, a PTRS, and/or other reference signal. For example, the configuration information may indicate whether resource muting is to be applied during OFDM symbols that are configured with a reference signal, such as a DMRS, a PTRS, and/or other reference signal, as described in more detail elsewhere herein. The UE 120 may consider OFDM symbols, during the second time interval, that are configured with a reference signal when identifying the first one or more time intervals if the UE 120 determines that resource muting is to be applied during OFDM symbols that are configured with the reference signal. For example, when counting OFDM symbols (e.g., from the start or the end of the second time interval) to identify the first one or more time intervals, the UE 120 may count OFDM symbols that are configured with the reference signal. In some other aspects, if the UE 120 determines that resource muting is not to be applied during OFDM symbols that are configured with the reference signal, then the UE 120 may not consider OFDM symbols, during the second time interval, that are configured with the reference signal. In other words, the UE 120 may identify the first one or more time intervals irrespective of OFDM symbols, during the second time interval, that are configured with the reference signal. For example, when counting OFDM symbols (e.g., from the start or the end of the second time interval) to identify the first one or more time intervals, the UE 120 may not count OFDM symbols that are configured with the reference signal.

In some aspects, the UE 120 may determine whether the resource muting is applicable for one or more signals (e.g., for one or more communications). For example, the UE 120 may determine whether the configured and/or activated resource muting pattern is to be applied for one or more signals (e.g., for one or more communications) in accordance with the configuration information. As an example, the UE 120 may determine whether the configured and/or activated resource muting pattern is to be applied for one or more signals (e.g., for one or more communications) based at least in part on, or otherwise associated with, a reference signal configuration or allocation. For example, if all configured CDM groups are allocated for the reference signal or REs having both even index values and odd index values are to be used to transmit the reference signal (e.g., as indicated by the

$${k}_{r e f}^{R E}$$

parameter for a PTRS), then the UE 120 may determine that resource muting is not applicable for the one or more signals (e.g., for the one or more communications). In such examples, the UE 120 may refrain from applying the resource muting pattern for the one or more signals.

As shown by reference number 725, the UE 120 may apply the resource muting pattern to the identified time interval(s) (e.g., the first one or more time intervals). For example, the UE 120 may mute (e.g., refrain from transmitting via) one or more time-frequency resources (e.g., one or more RBs or one or more REs) during the first one or more time intervals. The one or more time-frequency resources may be indicated by the resource muting pattern. In some other aspects, the UE 120 may refrain from applying the resource muting pattern to the identified time interval(s), such as if all configured CDM groups are allocated for the reference signal or REs having both even index values and odd index values are to be used to transmit the reference signal (e.g., as indicated by the

$${k}_{r e f}^{R E}$$

parameter for a PTRS).

In some aspects, the UE 120 may apply the resource muting pattern to a time interval that is configured with a reference signal. As an example, the reference signal (e.g., a DMRS) may be configured with multiple CDM groups. In some aspects, at least one CDM group may not be allocated for the second time interval. In such examples, the UE 120 may mute time-frequency resources, in accordance with the resource muting pattern, associated with the at least one CDM group. For example, a DMRS may be configured with a first CDM group and a second CDM group. The UE 120 may receive an indication that the first CDM group is allocated for the second time interval (e.g., and the second CDM group is not allocated). The UE 120 may apply the resource muting pattern for time-frequency resources (e.g., REs) associated with the second CDM group. As another example, a configuration parameter (e.g., the

$${k}_{r e f}^{R E}$$

parameter for a PTRS) may indicate one or more time-frequency resources allocated for the reference signal, such as resource elements having an even index value or resource elements having an odd index value. The UE 120 may apply the resource muting pattern to time-frequency resources that are not indicated as being allocated to the reference signal (e.g., the PTRS) by the configuration parameter. For example, if the configuration parameter indicates that the reference signal (e.g., the PTRS) is allocated for resource elements having an even index value, then the UE 120 may mute one or more time-frequency resources include resource elements having an odd index value. Alternatively, if the configuration parameter indicates that the reference signal (e.g., the PTRS) is allocated for resource elements having an odd index value, then the UE 120 may mute one or more time-frequency resources include resource elements having an even index value. This may reduce the likelihood of the resource muting impacting the performance of the reference signal.

As shown by reference number 730, the UE 120 may select one or more time-frequency resources for transmission during the second time interval. For example, the second time interval may be associated with a set of resources (e.g., a set of time-frequency resources). The UE 120 may select the one or more time-frequency resources from available time-frequency resources in accordance with the resource muting pattern. “Available” resource refers to a resource (e.g., a time-frequency resource) that is not muted in accordance with the resource muting pattern. For example, the UE 120 may refrain from selecting muted time-frequency resources (e.g., time-frequency resources that are muted following the resource muting pattern applied by the UE 120 as described in connection with reference number 725).

In some aspects, as shown by reference number 735, the UE 120 may transmit, and the network node 110 may receive, one or more signals, during the second time interval, using the selected time-frequency resources (e.g., selected by the UE 120 as described in connection with reference number 730). For example, the UE 120 may transmit one or more signals in one or more available resources, from the set of resources included in the second time interval, in accordance with the resource muting pattern. In some other aspects, the UE 120 may refrain from transmitting the one or more signals, such as if the UE 120 determines that the one or more signals should be dropped as described in more detail elsewhere herein. Dropping the one or more signals may improve the performance of CLI measurements performed by the network node 110 because the UE 120 may ensure that uplink signal(s) are not transmitted during time-frequency resources in which the network node 110 is performing the CLI measurements.

As shown by reference number 740, the network node 110 may perform, during the first one or more time intervals, one or more CLI measurements using muted resources included in the set of resources as indicated by the resource muting pattern. For example, another network node 110 (not shown in FIG. 7) may transmit one or more CLI reference signals using the muted resources (e.g., muted REs or muted RBs). The network node 110 may measure the one or more CLI reference signals to obtain one or more CLI measurements. The network node 110 (or another network node 110) may use the one or more CLI measurements to adjust, set, and/or optimize one or more communication parameters associated with full-duplex operation. This may improve the performance of the network node 110 for the full-duplex operation mode.

As indicated above, FIG. 7 is provided as an example. Other examples may differ from what is described with respect to FIG. 7.

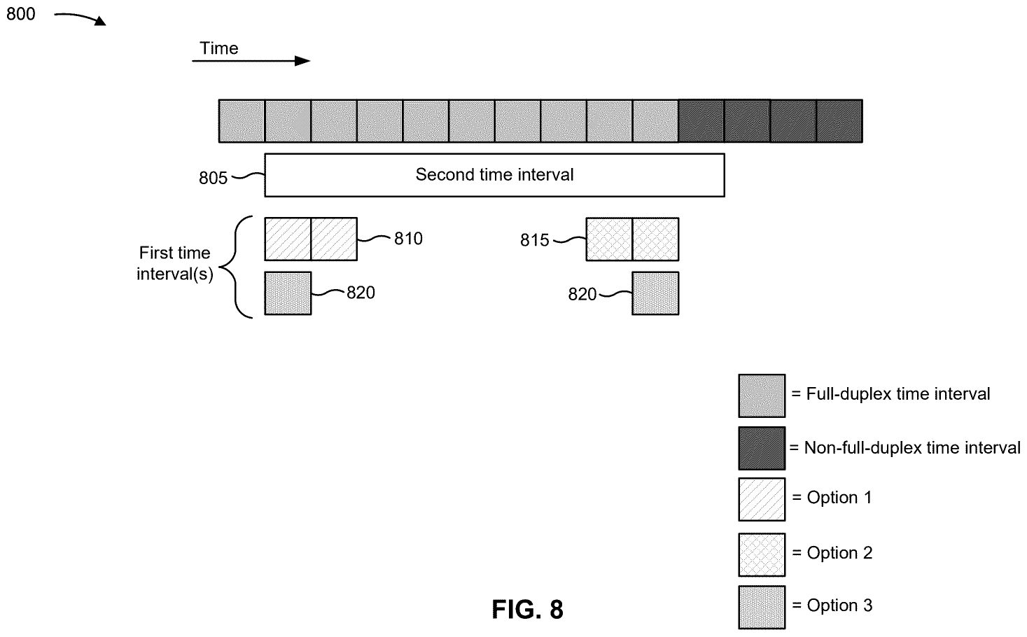

FIG. 8 is a diagram of an example 800 associated with resource muting patterns. In the example 800, the resource muting pattern is applicable to two time intervals (e.g., two OFDM symbols) during a second time interval 805. However, in other aspects, the resource muting pattern is applicable to other quantities of time intervals (e.g., one OFDM symbol, three OFDM symbols, or another quantity of OFDM symbols) in a similar manner as described herein.

The second time interval 805 may be a time domain resource allocation, such as for a given channel. As an example, the second time interval may be a PUSCH time domain resource allocation, a PUCCH time domain resource allocation, a sidelink time domain resource allocation, or another type of time domain resource allocation. As shown in FIG. 8, the second time interval 805 may include one or more full-duplex time intervals and one or more non-full-duplex time intervals. A “full-duplex time interval” may be a time interval (e.g., an OFDM symbol) that is configured for full-duplex operation by the UE 120 and/or the network node 110. For example, a full-duplex time interval may be an OFDM symbol in which SBFD operation is configured, as described in more detail elsewhere herein. A “non-full-duplex time interval” may be a time interval (e.g., an OFDM symbol) that is not configured for full-duplex operation by the UE 120 and the network node 110 and/or that is configured for half-duplex operation by the UE 120 and the network node 110. In some aspects, the second time interval 805 may be a portion of a slot, a mini-slot, a subframe, or another time interval.

In some aspects, the one or more first time intervals (e.g., during which the UE 120 is to apply the resource muting pattern) may be consecutive or contiguous in the time domain (e.g., as shown by reference number 810 and reference number 815). In other examples, the multiple time intervals may not be consecutive or contiguous in the time domain (e.g., there may be a gap in the time domain between the multiple time intervals), such as shown by reference number 820. As an example, as shown by reference number 810, the UE 120 may apply resource muting during the K^{th} OFDM symbol and the L^{th} OFDM symbol (e.g., that are configured for full-duplex operation) of the time domain resource allocation relative to the start of the second time interval 805 (e.g., relative to a first OFDM symbol in time that is configured for full-duplex operation). For example, the resource muting pattern may be applied during the first and second (e.g., in time) full-duplex time intervals within the second time interval 805 as shown by reference number 810 in FIG. 8. As another example, as shown by reference number 815, the UE 120 may apply resource muting during the K^{th} OFDM symbol and the L^{th} OFDM symbol (e.g., that are configured for full-duplex operation) of the time domain resource allocation relative to the end of the second time interval 805 (e.g., relative to a last OFDM symbol in time that is configured for full-duplex operation). For example, the resource muting pattern may be applied during the last and second to last (e.g., in time) full-duplex time intervals within the second time interval 805. As another example, as shown by reference number 820, the UE 120 may apply resource muting during the K^{th} OFDM symbol relative to the start of the time domain resource allocation and to the L^{th} OFDM symbol relative to the end of the time domain resource allocation. For example, the resource muting pattern may be applied during the first and last (e.g., in time) full-duplex time intervals within the second time interval 805.

As indicated above, FIG. 8 is provided as an example. Other examples may differ from what is described with respect to FIG. 8.

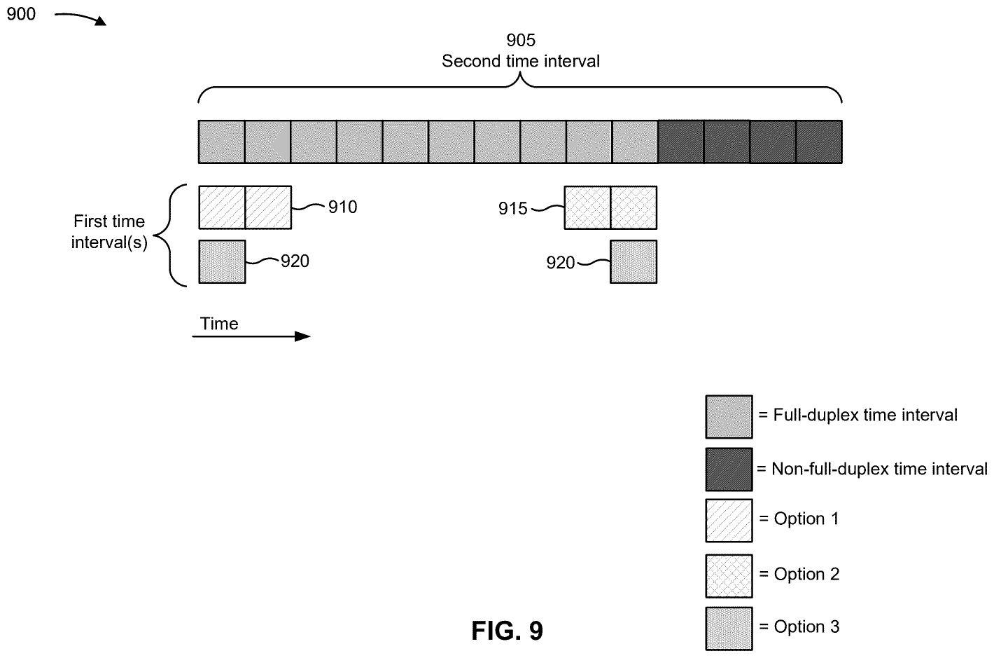

FIG. 9 is a diagram of an example 900 associated with resource muting patterns. In the example 900, the resource muting pattern is applicable to two time intervals (e.g., two OFDM symbols) during a second time interval 905. However, in other aspects, the resource muting pattern is applicable to other quantities of time intervals (e.g., one OFDM symbol, three OFDM symbols, or another quantity of OFDM symbols) in a similar manner as described herein.

The second time interval 905 may be a slot, a mini-slot, a set of OFDM symbols, a subframe, or another time interval. As shown in FIG. 9, the second time interval 905 may include one or more full-duplex time intervals and one or more non-full-duplex time intervals.

As an example, as shown by reference number 910, the UE 120 may apply resource muting during the K^{th} OFDM symbol and the L^{th} OFDM symbol (e.g., that are configured for full-duplex operation) of the second time interval 905 relative to the start of the second time interval 905 (e.g., relative to a first OFDM symbol in time that is configured for full-duplex operation). For example, the resource muting pattern is to be applied during the first and second (e.g., in time) full-duplex time intervals within the subframe, the slot, or the mini-slot. As another example, as shown by reference number 915, the UE 120 may apply resource muting during the K^{th} OFDM symbol and the L^{th} OFDM symbol (e.g., that are configured for full-duplex operation) of the second time interval 905 relative to the end of second time interval 905 (e.g., relative to a last OFDM symbol in time that is configured for full-duplex operation). For example, the resource muting pattern may be applied during the last and second to last (e.g., in time) full-duplex time intervals within the second time interval 905. As another example, as shown by reference number 920, the UE 120 may apply resource muting during the K^{th} OFDM symbol relative to the start of second time interval 905 and to the L^{th} OFDM symbol relative to the end of the second time interval 905. For example, the configuration information may indicate that the resource muting pattern is to be applied during the first and last (e.g., in time) full-duplex time intervals within the second time interval 905.

As indicated above, FIG. 9 is provided as an example. Other examples may differ from what is described with respect to FIG. 9.

FIG. 10 is a diagram illustrating an example process 1000 performed, for example, at a UE or an apparatus of a UE. Example process 1000 is an example where the apparatus or the UE (e.g., UE 120) performs operations associated with resource muting patterns.

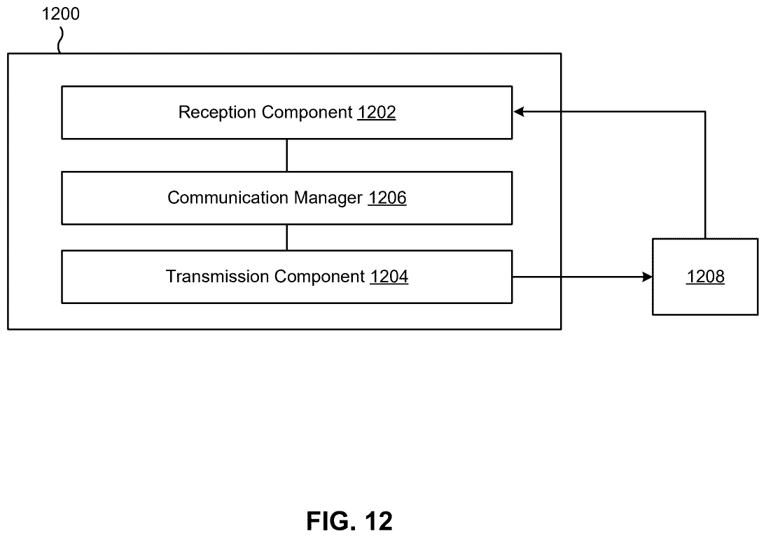

As shown in FIG. 10, in some aspects, process 1000 may include receiving configuration information indicating a resource muting pattern, wherein the resource muting pattern is associated with a first one or more symbols, within a time interval associated with a set of resources, during which the resource muting pattern is to be applied, and wherein one or more positions of the first one or more symbols is based at least in part on the time interval (block 1010). For example, the UE (e.g., using reception component 1202 and/or communication manager 1206, depicted in FIG. 12) may receive configuration information indicating a resource muting pattern, wherein the resource muting pattern is associated with a first one or more symbols, within a time interval associated with a set of resources, during which the resource muting pattern is to be applied, and wherein one or more positions of the first one or more symbols is based at least in part on the time interval, as described above.

As further shown in FIG. 10, in some aspects, process 1000 may include transmitting one or more signals in one or more available resources, from the set of resources, in accordance with the resource muting pattern (block 1020). For example, the UE (e.g., using transmission component 1204 and/or communication manager 1206, depicted in FIG. 12) may transmit one or more signals in one or more available resources, from the set of resources, in accordance with the resource muting pattern, as described above.

Process 1000 may include additional aspects, such as any single aspect or any combination of aspects described below and/or in connection with one or more other processes described elsewhere herein.

In a first aspect, the one or more positions of the first one or more symbols are indicated by the configuration information relative to a start of the time interval.

In a second aspect, alone or in combination with the first aspect, the one or more positions of the first one or more symbols are indicated by the configuration information relative to an end of the time interval.

In a third aspect, alone or in combination with one or more of the first and second aspects, the time interval includes a second one or more symbols with a reference signal.

In a fourth aspect, alone or in combination with one or more of the first through third aspects, the first one or more symbols include the second one or more symbols.

In a fifth aspect, alone or in combination with one or more of the first through fourth aspects, the first one or more symbols do not include the second one or more symbols based at least in part on the second one or more symbols having the reference signal.

In a sixth aspect, alone or in combination with one or more of the first through fifth aspects, the configuration information indicates whether the resource muting pattern is to include symbols associated with the reference signal.

In a seventh aspect, alone or in combination with one or more of the first through sixth aspects, the first one or more symbols include the second one or more symbols based at least in part on the configuration information indicating that the resource muting pattern is to include symbols associated with the reference signal.

In an eighth aspect, alone or in combination with one or more of the first through seventh aspects, the first one or more symbols do not include the second one or more symbols based at least in part on the configuration information indicating that the resource muting pattern does not include symbols associated with the reference signal.

In a ninth aspect, alone or in combination with one or more of the first through eighth aspects, the time interval includes a time domain resource allocation for the one or more signals, wherein the time domain resource allocation does not include available symbols without the reference signal, and wherein the first one or more symbols include the second one or more symbols based at least in part on the time domain resource allocation not including available symbols without the reference signal.

In a tenth aspect, alone or in combination with one or more of the first through ninth aspects, the time interval includes a time domain resource allocation for the one or more signals, and wherein the first one or more symbols include the second one or more symbols based at least in part on a size of the time domain resource allocation not satisfying a threshold.

In an eleventh aspect, alone or in combination with one or more of the first through tenth aspects, the reference signal is associated with a configuration type, and wherein the first one or more symbols include the second one or more symbols based at least in part on the configuration type being compatible with the resource muting pattern.

In a twelfth aspect, alone or in combination with one or more of the first through eleventh aspects, the first one or more symbols include the second one or more symbols, wherein the reference signal is associated with a first CDM group of multiple CDM groups, wherein the resource muting pattern is applicable based at least in part on a second CDM group, of the multiple CDM groups, not being associated with the reference signal.

In a thirteenth aspect, alone or in combination with one or more of the first through twelfth aspects, the reference signal is associated with multiple CDM groups, and wherein the resource muting pattern is not applicable to the one or more signals based at least in part on the multiple CDM groups being associated with the reference signal.

In a fourteenth aspect, alone or in combination with one or more of the first through thirteenth aspects, the time interval includes a fourth one or more symbols that are not associated with the reference signal, and wherein the resource muting pattern is applicable to the one or more signals based at least in part on a quantity of the fourth one or more symbols satisfying a threshold.

In a fifteenth aspect, alone or in combination with one or more of the first through fourteenth aspects, the first one or more symbols include the second one or more symbols, wherein a configuration parameter of the reference signal indicates that the reference signal is to be included in a first one or more time-frequency resources, and wherein the resource muting pattern is applicable to a second one or more time-frequency resources included in the second one or more symbols based at least in part on the configuration parameter indicating that the reference signal is to be included in the first one or more time-frequency resources.

In a sixteenth aspect, alone or in combination with one or more of the first through fifteenth aspects, the first one or more time-frequency resources include resource elements having an even index value, and wherein the second one or more time-frequency resources include resource elements having an odd index value.

In a seventeenth aspect, alone or in combination with one or more of the first through sixteenth aspects, the first one or more time-frequency resources include resource elements having an odd index value, and wherein the second one or more time-frequency resources include resource elements having an even index value.

In an eighteenth aspect, alone or in combination with one or more of the first through seventeenth aspects, a configuration parameter of the reference signal indicates that the reference signal is to be included in resource elements having both an even index value and an odd index value, and wherein the resource muting pattern is not applicable to the one or more signals based at least in part on the configuration parameter indicating that the reference signal is to be included in resource elements having both the even index value and the odd index value.

In a nineteenth aspect, alone or in combination with one or more of the first through eighteenth aspects, the first one or more symbols do not include the second one or more symbols, and process 1000 includes identifying the first one or more symbols irrespective of the second one or more symbols.

In a twentieth aspect, alone or in combination with one or more of the first through nineteenth aspects, the reference signal is a demodulation reference signal.

In a twenty-first aspect, alone or in combination with one or more of the first through twentieth aspects, the reference signal is a phase tracking reference signal.

In a twenty-second aspect, alone or in combination with one or more of the first through twenty-first aspects, the second one or more symbols include one or more OFDM symbols.

In a twenty-third aspect, alone or in combination with one or more of the first through twenty-second aspects, the first one or more symbols include one or more OFDM symbols configured for full duplex communication.

In a twenty-fourth aspect, alone or in combination with one or more of the first through twenty-third aspects, the time interval includes a time domain resource allocation for the one or more signals.

In a twenty-fifth aspect, alone or in combination with one or more of the first through twenty-fourth aspects, the one or more signals are transmitted during the time interval.

In a twenty-sixth aspect, alone or in combination with one or more of the first through twenty-fifth aspects, the time interval includes a slot or a mini-slot.

In a twenty-seventh aspect, alone or in combination with one or more of the first through twenty-sixth aspects, the one or more signals are physical uplink shared channel signals.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node. Example process 1100 is an example where the apparatus or the network node (e.g., network node 110) performs operations associated with resource muting patterns.

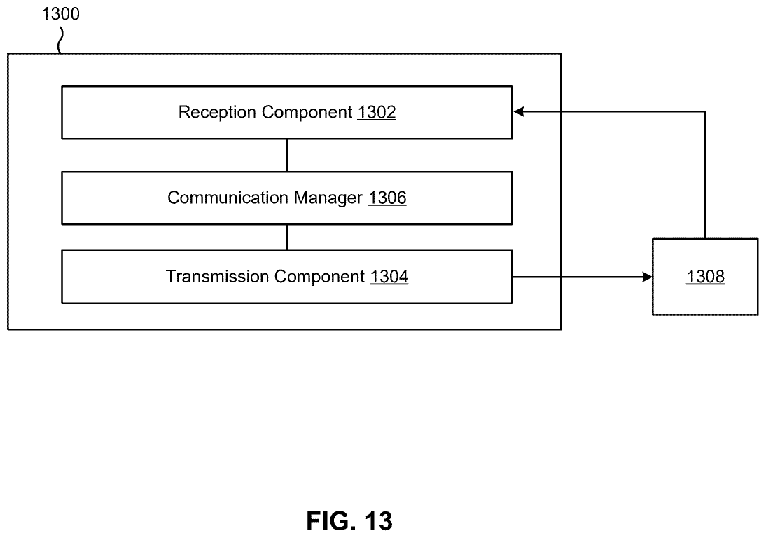

As shown in FIG. 11, in some aspects, process 1100 may include transmitting configuration information indicating a resource muting pattern, wherein the resource muting pattern is associated with a first one or more symbols, within a time interval associated with a set of resources, during which the resource muting pattern is to be applied, and wherein one or more positions of the first one or more symbols is based at least in part on the time interval (block 1110). For example, the network node (e.g., using transmission component 1304 and/or communication manager 1306, depicted in FIG. 13) may transmit configuration information indicating a resource muting pattern, wherein the resource muting pattern is associated with a first one or more symbols, within a time interval associated with a set of resources, during which the resource muting pattern is to be applied, and wherein one or more positions of the first one or more symbols is based at least in part on the time interval, as described above.

As further shown in FIG. 11, in some aspects, process 1100 may include receiving one or more signals in one or more available resources, from the set of resources, in accordance with the resource muting pattern (block 1120). For example, the network node (e.g., using reception component 1302 and/or communication manager 1306, depicted in FIG. 13) may receive one or more signals in one or more available resources, from the set of resources, in accordance with the resource muting pattern, as described above.

Process 1100 may include additional aspects, such as any single aspect or any combination of aspects described below and/or in connection with one or more other processes described elsewhere herein.

In a first aspect, process 1100 includes performing, during the first one or more symbols, one or more cross link interface measurements using muted resources included in the set of resources as indicated by the resource muting pattern.

In a second aspect, alone or in combination with the first aspect, the one or more positions of the first one or more symbols are indicated by the configuration information relative to a start of the time interval.

In a third aspect, alone or in combination with one or more of the first and second aspects, the one or more positions of the first one or more symbols are indicated by the configuration information relative to an end of the time interval.

In a fourth aspect, alone or in combination with one or more of the first through third aspects, the time interval includes a second one or more symbols with a reference signal.

In a fifth aspect, alone or in combination with one or more of the first through fourth aspects, the first one or more symbols include the second one or more symbols.

In a sixth aspect, alone or in combination with one or more of the first through fifth aspects, the first one or more symbols do not include the second one or more symbols based at least in part on the second one or more symbols having the reference signal.

In a seventh aspect, alone or in combination with one or more of the first through sixth aspects, the configuration information indicates whether the resource muting pattern is to include symbols associated with the reference signal.

In an eighth aspect, alone or in combination with one or more of the first through seventh aspects, the first one or more symbols include the second one or more symbols based at least in part on the configuration information indicating that the resource muting pattern is to include symbols associated with the reference signal.

In a ninth aspect, alone or in combination with one or more of the first through eighth aspects, the first one or more symbols do not include the second one or more symbols based at least in part on the configuration information indicating that the resource muting pattern does not include symbols associated with the reference signal.

In a tenth aspect, alone or in combination with one or more of the first through ninth aspects, the time interval includes a time domain resource allocation for the one or more signals, wherein the time domain resource allocation does not include available symbols without the reference signal, and wherein the first one or more symbols include the second one or more symbols based at least in part on the time domain resource allocation not including available symbols without the reference signal.

In an eleventh aspect, alone or in combination with one or more of the first through tenth aspects, the time interval includes a time domain resource allocation for the one or more signals, and wherein the first one or more symbols include the second one or more symbols based at least in part on a size of the time domain resource allocation not satisfying a threshold.

In a twelfth aspect, alone or in combination with one or more of the first through eleventh aspects, the reference signal is associated with a configuration type, and wherein the first one or more symbols include the second one or more symbols based at least in part on the configuration type being compatible with the resource muting pattern.

In a thirteenth aspect, alone or in combination with one or more of the first through twelfth aspects, the first one or more symbols include the second one or more symbols, wherein the reference signal is associated with a first CDM group of multiple CDM groups, and wherein the resource muting pattern is based at least in part on a second CDM group, of the multiple CDM groups, not being associated with the reference signal.

In a fourteenth aspect, alone or in combination with one or more of the first through thirteenth aspects, the reference signal is associated with multiple CDM groups, and wherein the resource muting pattern is not applicable to the one or more signals based at least in part on multiple CDM groups being allocated for the one or more signals.

In a fifteenth aspect, alone or in combination with one or more of the first through fourteenth aspects, the time interval includes a fourth one or more symbols that are not associated with the reference signal, and wherein the resource muting pattern is applicable to the one or more signals based at least in part on a quantity of the fourth one or more symbols satisfying a threshold.

In a sixteenth aspect, alone or in combination with one or more of the first through fifteenth aspects, the first one or more symbols include the second one or more symbols, wherein a configuration parameter of the reference signal indicates that the reference signal is to be included in a first one or more time-frequency resources, and wherein the resource muting pattern is applicable to a second one or more time-frequency resources included in the second one or more symbols based at least in part on the configuration parameter indicating that the reference signal is to be included in the first one or more time-frequency resources.

In a seventeenth aspect, alone or in combination with one or more of the first through sixteenth aspects, the first one or more time-frequency resources include resource elements having an even index value, and wherein the second one or more time-frequency resources include resource elements having an odd index value.

In an eighteenth aspect, alone or in combination with one or more of the first through seventeenth aspects, the first one or more time-frequency resources include resource elements having an odd index value, and wherein the second one or more time-frequency resources include resource elements having an even index value.

In a nineteenth aspect, alone or in combination with one or more of the first through eighteenth aspects, a configuration parameter of the reference signal indicates that the reference signal is to be included in resource elements having both an even index value and an odd index value, and wherein the resource muting pattern is not applicable to the one or more signals based at least in part on the configuration parameter indicating that the reference signal is to be included in resource elements having both the even index value and the odd index value.

In a twentieth aspect, alone or in combination with one or more of the first through nineteenth aspects, the first one or more symbols do not include the second one or more symbols, and the process 1100 includes identifying the first one or more symbols irrespective of the second one or more symbols.

In a twenty-first aspect, alone or in combination with one or more of the first through twentieth aspects, the reference signal is a demodulation reference signal.

In a twenty-second aspect, alone or in combination with one or more of the first through twenty-first aspects, the reference signal is a phase tracking reference signal.

In a twenty-third aspect, alone or in combination with one or more of the first through twenty-second aspects, the second one or more symbols include one or more OFDM symbols.

In a twenty-fourth aspect, alone or in combination with one or more of the first through twenty-third aspects, the first one or more symbols include one or more OFDM symbols configured for full duplex communication.

In a twenty-fifth aspect, alone or in combination with one or more of the first through twenty-fourth aspects, the time interval includes a time domain resource allocation for the one or more signals.

In a twenty-sixth aspect, alone or in combination with one or more of the first through twenty-fifth aspects, the one or more signals are transmitted during the time interval.

In a twenty-seventh aspect, alone or in combination with one or more of the first through twenty-sixth aspects, the time interval includes a slot or a mini-slot.

In a twenty-eighth aspect, alone or in combination with one or more of the first through twenty-seventh aspects, the one or more signals are physical uplink shared channel signals.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7-9. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the UE described in connection with FIG. 1 and FIG. 2. Additionally, or alternatively, one or more components shown in FIG. 12 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive configuration information indicating a resource muting pattern, wherein the resource muting pattern is associated with a first one or more symbols, within a time interval associated with a set of resources, during which the resource muting pattern is to be applied, and wherein one or more positions of the first one or more symbols is based at least in part on the time interval. The transmission component 1204 may transmit one or more signals in one or more available resources, from the set of resources, in accordance with the resource muting pattern.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 7-9. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the network node described in connection with FIG. 1 and FIG. 2. Additionally, or alternatively, one or more components shown in FIG. 13 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit configuration information indicating a resource muting pattern, wherein the resource muting pattern is associated with a first one or more symbols, within a time interval associated with a set of resources, during which the resource muting pattern is to be applied, and wherein one or more positions of the first one or more symbols is based at least in part on the time interval. The reception component 1302 may receive one or more signals in one or more available resources, from the set of resources, in accordance with the resource muting pattern.

The communication manager 1306 may perform, during the first one or more symbols, one or more cross link interface measurements using muted resources included in the set of resources as indicated by the resource muting pattern.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a user equipment (UE), comprising: receiving configuration information indicating a resource muting pattern, wherein the resource muting pattern is associated with a first one or more symbols, within a time interval associated with a set of resources, during which the resource muting pattern is to be applied; and transmitting one or more signals in one or more available resources, from the set of resources, in accordance with the resource muting pattern.
Aspect 2: The method of Aspect 1, wherein the one or more positions of the first one or more symbols are indicated by the configuration information relative to a start of the time interval.
Aspect 3: The method of any of Aspects 1-2, wherein the one or more positions of the first one or more symbols are indicated by the configuration information relative to an end of the time interval.
Aspect 4: The method of any of Aspects 1-3, wherein the time interval includes a second one or more symbols with a reference signal.
Aspect 5: The method of Aspect 4, wherein the first one or more symbols, during which the resource muting pattern is to be applied, include the second one or more symbols with the reference signal.
Aspect 6: The method of Aspect 4, wherein the first one or more symbols, during which the resource muting pattern is to be applied, do not include the second one or more symbols based at least in part on the second one or more symbols having the reference signal.
Aspect 7: The method of any of Aspects 4-6, wherein the configuration information indicates whether the resource muting pattern is to include symbols having the reference signal.
Aspect 8: The method of Aspect 7, wherein the first one or more symbols, during which the resource muting pattern is to be applied, include the second one or more symbols based at least in part on the configuration information indicating that the resource muting pattern is to include symbols having the reference signal.
Aspect 9: The method of Aspect 7, wherein the first one or more symbols do not include the second one or more symbols based at least in part on the configuration information indicating that the resource muting pattern does not include symbols having the reference signal.
Aspect 10: The method of any of Aspects 4, 5, 7, and 8, wherein the time interval includes a time domain resource allocation for the one or more signals, wherein the time domain resource allocation does not include available symbols without the reference signal, and wherein the first one or more symbols, during which the resource muting pattern is to be applied, include the second one or more symbols with the reference signal based at least in part on the time domain resource allocation not including available symbols without the reference signal.
Aspect 11: The method of Aspect any of Aspects 4, 5, and 7, 8 and 10, wherein the time interval includes a time domain resource allocation for the one or more signals, and wherein the first one or more symbols, during which the resource muting pattern is to be applied, include the second one or more symbols with the reference signal based at least in part on a size of the time domain resource allocation not satisfying a threshold.
Aspect 12: The method of any of Aspects 4, 5, and 7, 8, 10 and 11, wherein the reference signal is associated with a configuration type, and wherein the first one or more symbols, during which the resource muting pattern is to be applied, include the second one or more symbols with the reference signal based at least in part on the configuration type being compatible with the resource muting pattern.
Aspect 13: The method of any of Aspects 4, 5, and 7, 8, and 10-12, wherein the first one or more symbols, during which the resource muting pattern is to be applied, include the second one or more symbols, wherein the reference signal is associated with a first code division multiplexing (CDM) group of multiple code division multiplexing (CDM) groups, wherein the resource muting pattern is applicable to the one or more signals based at least in part on a second CDM group, of the multiple CDM groups, not having the reference signal.
Aspect 14: The method of Aspect 4, wherein the reference signal is associated with multiple code division multiplexing (CDM) groups, and wherein the resource muting pattern is not applicable to the one or more signals based at least in part on the multiple CDM groups having the reference signal.
Aspect 15: The method of any of Aspects 4, 5, and 7, 8, 10-12, and 14, wherein the time interval includes a third one or more symbols that are not associated with the reference signal, and wherein the resource muting pattern is applicable to the one or more signals based at least in part on a quantity of the third one or more symbols satisfying a threshold.
Aspect 16: The method of any of Aspects 4, 5, and 7, 8, 10-12, 14, and 15, wherein the first one or more symbols, during which the resource muting pattern is to be applied, include the second one or more symbols, wherein a configuration parameter of the reference signal indicates that the reference signal is to be included in a first one or more time-frequency resources, and wherein the resource muting pattern is applicable to a second one or more time-frequency resources included in the second one or more symbols based at least in part on the configuration parameter indicating that the reference signal is to be included in the first one or more time-frequency resources.
Aspect 17: The method of Aspect 16, wherein the first one or more time-frequency resources include resource elements having an even index value, and wherein the second one or more time-frequency resources include resource elements having an odd index value.
Aspect 18: The method of Aspect 16, wherein the first one or more time-frequency resources include resource elements having an odd index value, and wherein the second one or more time-frequency resources include resource elements having an even index value.
Aspect 19: The method of any of Aspects 4, 6, and 7, wherein a configuration parameter of the reference signal indicates that the reference signal is to be included in resource elements having both an even index value and an odd index value, and wherein the resource muting pattern is not applicable to the one or more signals based at least in part on the configuration parameter indicating that the reference signal is to be included in resource elements having both the even index value and the odd index value.
Aspect 20: The method of any of Aspects 4, 6, 7, and 19 wherein the first one or more symbols do not include symbols with the reference signal, and the method further comprising: identifying the first one or more symbols irrespective of the second one or more symbols.
Aspect 21: The method of any of Aspects 4-20, wherein the reference signal is a demodulation reference signal.
Aspect 22: The method of any of Aspects 4-20, wherein the reference signal is a phase tracking reference signal.
Aspect 23: The method of any of Aspects 4-22, wherein the second one or more symbols include one or more orthogonal frequency division multiplexing (OFDM) symbols.
Aspect 24: The method of any of Aspects 1-23, wherein the first one or more symbols include one or more orthogonal frequency division multiplexing (OFDM) symbols configured for full duplex communication.
Aspect 25: The method of any of Aspects 1-24, wherein the time interval includes a time domain resource allocation for the one or more signals.
Aspect 26: The method of any of Aspects 1-25, wherein the one or more signals are transmitted during the time interval.
Aspect 27: The method of any of Aspects 1-26, wherein the time interval includes a slot or a mini-slot.
Aspect 28: The method of any of Aspects 1-27, wherein the one or more signals are physical uplink shared channel signals.
Aspect 29: The method of any of Aspects 1-28, wherein the time interval is a slot, and wherein the set of resources include physical uplink shared channel (PUSCH) resources.
Aspect 30: The method of any of Aspects 1-28, further comprising: receiving downlink control information that indicates whether the resource muting pattern is to be applied.
Aspect 31: The method of any of Aspects 1-29, wherein the configuration information indicates whether the resource muting pattern includes symbols associated with a reference signal.
Aspect 32: The method of Aspect 31, wherein the reference signal is a phase tracking reference signal.
Aspect 33: The method of any of Aspects 1-32, wherein one or more positions of the first one or more symbols is based at least in part on the time interval.
Aspect 34: A method of wireless communication performed by a network node, comprising: transmitting configuration information indicating a resource muting pattern, wherein the resource muting pattern is associated with a first one or more symbols, within a time interval associated with a set of resources, during which the resource muting pattern is to be applied; and receiving one or more signals in one or more available resources, from the set of resources, in accordance with the resource muting pattern.
Aspect 35: The method of Aspect 34, further comprising: performing, during the first one or more symbols, one or more cross link interface measurements using muted resources included in the set of resources as indicated by the resource muting pattern.
Aspect 36: The method of any of Aspects 34-35, wherein the one or more positions of the first one or more symbols are indicated by the configuration information relative to a start of the time interval.
Aspect 37: The method of any of Aspects 34-36, wherein the one or more positions of the first one or more symbols are indicated by the configuration information relative to an end of the time interval.
Aspect 38: The method of any of Aspects 34-37, wherein the time interval includes a second one or more symbols with a reference signal.
Aspect 39: The method of Aspect 38, wherein the first one or more symbols include, during which the resource muting pattern is to be applied, the second one or more symbols with the reference signal.
Aspect 40: The method of Aspect 38, wherein the first one or more symbols, during which the resource muting pattern is to be applied, do not include the second one or more symbols with the reference signal based at least in part on the second one or more symbols having the reference signal.
Aspect 41: The method of any of Aspects 38-40, wherein the configuration information indicates whether the resource muting pattern is to include symbols with the reference signal.
Aspect 42: The method of Aspect 41, wherein the first one or more symbols, during which the resource muting pattern is to be applied, include the second one or more symbols based at least in part on the configuration information indicating that the resource muting pattern is to include symbols with the reference signal.
Aspect 43: The method of Aspect 41, wherein the first one or more symbols, during which the resource muting pattern is to be applied, do not include the second one or more symbols based at least in part on the configuration information indicating that the resource muting pattern does not include symbols with the reference signal.
Aspect 44: The method of any of Aspects 38, 39, 41, and 42, wherein the time interval includes a time domain resource allocation for the one or more signals, wherein the time domain resource allocation does not include available symbols without the reference signal, and wherein the first one or more symbols, during which the resource muting pattern is to be applied, include the second one or more symbols with the reference signal based at least in part on the time domain resource allocation not including available symbols without the reference signal.
Aspect 45: The method of any of Aspects 38, 39, 41, 42, and 44, wherein the time interval includes a time domain resource allocation for the one or more signals, and wherein the first one or more symbols, during which the resource muting pattern is to be applied, include the second one or more symbols with the reference signal based at least in part on a size of the time domain resource allocation not satisfying a threshold.
Aspect 46: The method of any of Aspects 38, 39, 41, 42, 44, and 45, wherein the reference signal is associated with a configuration type, and wherein the first one or more symbols, during which the resource muting pattern is to be applied, include the second one or more symbols with the reference signal based at least in part on the configuration type being compatible with the resource muting pattern.
Aspect 47: The method of any of Aspects 38, 39, 41, 42, 44, 45, and 46, wherein the first one or more symbols, during which the resource muting pattern is to be applied, include the second one or more symbols with the reference signal, wherein the reference signal is associated with a first code division multiplexing (CDM) group of multiple CDM groups, and wherein the resource muting pattern is based at least in part on a second CDM group, of the multiple CDM groups, not having the reference signal.
Aspect 48: The method of any of Aspects 38, 40, 42, and 43, wherein the reference signal is associated with multiple code division multiplexing (CDM) groups, and wherein the resource muting pattern is not applicable to the one or more signals based at least in part on multiple CDM groups being allocated for the one or more signals.
Aspect 49: The method of any of Aspects 38, 39, 41, 42, 44, 45, 46, and 47, wherein the time interval includes a third one or more symbols without the reference signal, and wherein the resource muting pattern is applicable to the one or more signals based at least in part on a quantity of the third one or more symbols satisfying a threshold.
Aspect 50: The method of Aspects 38, 39, 41, 42, 44, 45, 46, 47, and 49 wherein the first one or more symbols include the second one or more symbols, wherein a configuration parameter of the reference signal indicates that the reference signal is to be included in a first one or more time-frequency resources, and wherein the resource muting pattern is applicable to a second one or more time-frequency resources included in the second one or more symbols based at least in part on the configuration parameter indicating that the reference signal is to be included in the first one or more time-frequency resources.
Aspect 51: The method of Aspect 50, wherein the first one or more time-frequency resources include resource elements having an even index value, and wherein the second one or more time-frequency resources include resource elements having an odd index value.
Aspect 52: The method of Aspect 50, wherein the first one or more time-frequency resources include resource elements having an odd index value, and wherein the second one or more time-frequency resources include resource elements having an even index value.
Aspect 53: The method of any of Aspects 38, 40, 41, 43, and 48, wherein a configuration parameter of the reference signal indicates that the reference signal is to be included in resource elements having both an even index value and an odd index value, and wherein the resource muting pattern is not applicable to the one or more signals based at least in part on the configuration parameter indicating that the reference signal is to be included in resource elements having both the even index value and the odd index value.
Aspect 54: The method of any of Aspects 38, 40, 41, 43, 48, and 49, wherein the first one or more symbols do not include symbols with the reference signal, and the method further comprising: identifying the first one or more symbols irrespective of the second one or more symbols.
Aspect 55: The method of any of Aspects 38-54, wherein the reference signal is a demodulation reference signal.
Aspect 56: The method of any of Aspects 38-54, wherein the reference signal is a phase tracking reference signal.
Aspect 57: The method of any of Aspects 38-56, wherein the second one or more symbols include one or more orthogonal frequency division multiplexing (OFDM) symbols.
Aspect 58: The method of any of Aspects 34-57, wherein the first one or more symbols include one or more orthogonal frequency division multiplexing (OFDM) symbols configured for full duplex communication.
Aspect 59: The method of any of Aspects 34-58, wherein the time interval includes a time domain resource allocation for the one or more signals.
Aspect 60: The method of any of Aspects 34-59, wherein the one or more signals are transmitted during the time interval.
Aspect 61: The method of any of Aspects 34-60, wherein the time interval includes a slot or a mini-slot.
Aspect 62: The method of any of Aspects 34-61, wherein the one or more signals are physical uplink shared channel signals.
Aspect 63: The method of any of Aspects 34-62, wherein the time interval is a slot, and wherein the set of resources include physical uplink shared channel (PUSCH) resources.
Aspect 64: The method of any of Aspects 34-63, further comprising:
transmitting downlink control information that indicates whether the resource muting pattern is to be applied.
Aspect 65: The method of any of Aspects 34-64, wherein the configuration information indicates whether the resource muting pattern includes symbols associated with a reference signal.
Aspect 66: The method of Aspect 65, wherein the reference signal is a phase tracking reference signal.
Aspect 67: The method of any of Aspects 34-66, wherein one or more positions of the first one or more symbols is based at least in part on the time interval.
Aspect 68: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-67.
Aspect 69: An apparatus for wireless communication at a device, the apparatus comprising one or more memories and one or more processors coupled to the one or more memories, the one or more processors configured to cause the device to perform the method of one or more of Aspects 1-67.
Aspect 70: An apparatus for wireless communication, the apparatus comprising at least one means for performing the method of one or more of Aspects 1-67.
Aspect 71: A non-transitory computer-readable medium storing code for wireless communication, the code comprising instructions executable by one or more processors to perform the method of one or more of Aspects 1-67.
Aspect 72: A non-transitory computer-readable medium storing a set of instructions for wireless communication, the set of instructions comprising one or more instructions that, when executed by one or more processors of a device, cause the device to perform the method of one or more of Aspects 1-67.
Aspect 73: A device for wireless communication, the device comprising a processing system that includes one or more processors and one or more memories coupled with the one or more processors, the processing system configured to cause the device to perform the method of one or more of Aspects 1-67.
Aspect 74: An apparatus for wireless communication at a device, the apparatus comprising one or more memories and one or more processors coupled to the one or more memories, the one or more processors individually or collectively configured to cause the device to perform the method of one or more of Aspects 1-67.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication, comprising:
one or more memories; and
one or more processors, coupled to the one or more memories, the one or more processors individually or collectively configured to:
receive configuration information indicating a resource muting pattern, wherein the resource muting pattern is associated with a first one or more symbols, within a time interval associated with a set of resources, during which the resource muting pattern is to be applied; and
transmit one or more signals in one or more available resources, from the set of resources, in accordance with the resource muting pattern.

2. The apparatus of claim 1, wherein the time interval is a slot, and wherein the set of resources include physical uplink shared channel (PUSCH) resources.

3. The apparatus of claim 1, wherein the one or more processors individually or collectively configured to:
receive downlink control information that indicates whether the resource muting pattern is to be applied.

4. The apparatus of claim 1, wherein the configuration information indicates one or more positions of the first one or more symbols relative to a start of the time interval.

5. The apparatus of claim 1, wherein the configuration information indicates one or more positions of the first one or more symbols relative to an end of the time interval.

6. The apparatus of claim 1, wherein the configuration information indicates whether the resource muting pattern includes symbols associated with a reference signal.

7. The apparatus of claim 6, wherein the reference signal is a phase tracking reference signal.

8. The apparatus of claim 1, wherein the time interval includes a second one or more symbols with a reference signal.

9. The apparatus of claim 8, wherein the first one or more symbols, during which the resource muting pattern is to be applied, include the second one or more symbols with the reference signal.

10. The apparatus of claim 8, wherein the first one or more symbols, during which the resource muting pattern is to be applied, do not include the second one or more symbols based at least in part on the second one or more symbols having the reference signal.

11. The apparatus of claim 8, wherein the time interval includes a time domain resource allocation for the one or more signals, wherein the time domain resource allocation does not include available symbols without the reference signal, and wherein the first one or more symbols, during which the resource muting pattern is to be applied, include the second one or more symbols with the reference signal based at least in part on the time domain resource allocation not including available symbols without the reference signal.

12. The apparatus of claim 8, wherein the time interval includes a time domain resource allocation for the one or more signals, and wherein the first one or more symbols, during which the resource muting pattern is to be applied, include the second one or more symbols with the reference signal based at least in part on a size of the time domain resource allocation not satisfying a threshold.

13. The apparatus of claim 8, wherein the reference signal is associated with a configuration type, and wherein the first one or more symbols, during which the resource muting pattern is to be applied, include the second one or more symbols with the reference signal based at least in part on the configuration type being compatible with the resource muting pattern.

14. A method of wireless communication performed by a user equipment (UE), comprising:
receiving configuration information indicating a resource muting pattern, wherein the resource muting pattern is associated with a first one or more symbols, within a time interval associated with a set of resources, during which the resource muting pattern is to be applied, and wherein one or more positions of the first one or more symbols is based at least in part on the time interval; and
transmitting one or more signals in one or more available resources, from the set of resources, in accordance with the resource muting pattern.

15. The method of claim 14, wherein the time interval is a slot, and wherein the set of resources include physical uplink shared channel (PUSCH) resources.

16. The method of claim 14, further comprising:
receiving downlink control information that indicates whether the resource muting pattern is to be applied.

17. The method of claim 14, wherein the configuration information indicates whether the resource muting pattern includes symbols associated with a reference signal.

18. The method of claim 17, wherein the reference signal is a phase tracking reference signal.

19. The method of claim 14, wherein the time interval includes a second one or more symbols with a reference signal.

20. A non-transitory computer-readable medium storing a set of instructions for wireless communication, the set of instructions comprising:
one or more instructions that, when executed by one or more processors of a user equipment (UE), cause the UE to:
receive configuration information indicating a resource muting pattern, wherein the resource muting pattern is associated with a first one or more symbols, within a time interval associated with a set of resources, during which the resource muting pattern is to be applied, and wherein one or more positions of the first one or more symbols is based at least in part on the time interval; and
transmit one or more signals in one or more available resources, from the set of resources, in accordance with the resource muting pattern.
